(19) United States
(12) Patent Application Publication
(10) Pub. No.: US 2026/0261885 A1
(43) Pub. Date: Sep. 3, 2026

(54) METHODS FOR AI/ML-BASED SENSING

(71) Applicant: InterDigital Patent Holdings, Inc., Wilmington, DE (US)

(72) Inventors: Guodong Zhang, Woodbury, NY (US); Philip Pietraski, Jericho, NY (US); Mohamed Amine Arfaoui, Montreal (CA); Asil Koc, Verdun (CA); John Kaewell, Jamison, PA (US); Daniel Steinbach, Commack, NY (US); Phillip Leithead, King of Prussia, PA (US); Sudhir Pattar, Mount Laurel, NJ (US)

(73) Assignee: InterDigital Patent Holdings, Inc., Wilmington, DE (US)

(21) Appl. No.: 19/067,570

(22) Filed: Feb. 28, 2025

(51) Int. Cl. H04W 24/08

(52) U.S. Cl. CPC H04W 24/08

(57) ABSTRACT

A method may be implemented by a wireless transmit/receive unit (WTRU), including receiving an indication from a network to perform measurements associated with uplink sensing, determining sensing node selection feedback based on the indication, transmitting the sensing node selection feedback to the network, and receiving an indication from the network assigning the WTRU to a sensing group. Configuration information for uplink sensing may be received and may include an indication of sensing resources, parameters, and a transmission mode. An indication to activate an uplink sensing resource among the sensing resources and a set of sensing signal parameters may be received, and may indicate the transmission mode. A sensing signal, the set of sensing signal parameters from the plurality of parameters, and the transmission mode that were activated may be sent via the at least one uplink sensing resource. The transmission mode may be a normal mode or pre-equalized transmission mode.

### BACKGROUND

Artificial intelligence (AI) may be broadly defined as the behavior exhibited by machines that mimic cognitive functions to sense, reason, adapt, and act. An AI component may refer to the realization of behaviors and/or conformance to requirements by learning based on data, without explicit configuration of a sequence of steps of actions. Such an AI component may enable learning complex behaviors that may be difficult to specify and/or implement when using legacy methods.

Machine learning (ML) may refer to the type of algorithms that solve a problem based on learning through experience (e.g., data) without being explicitly programmed (e.g., configuring a set of rules). ML may be considered a subset of AI. Different ML paradigms may be envisioned based on the nature of data or feedback available to the learning algorithm.

### SUMMARY

A wireless transmit/receive unit (WTRU) may be described herein. The WTRU may include a processor. The process may be configured to receive an indication from a network to perform measurements associated with uplink sensing, determine sensing node selection feedback based on the indication, transmit the sensing node selection feedback to the network, receive an indication from the network that assigns the WTRU to a sensing group, and receive configuration information associated with uplink sensing. The configuration information may include an indication of a plurality of sensing resources, a plurality of parameters, and an indication of a transmission mode. An indication to activate at least one uplink sensing resource among the plurality of sensing resources and a set of sensing signal parameters from the plurality of parameters may be received. The indication may indicate the transmission mode. A sensing signal, the set of sensing signal parameters from the plurality of parameters, and the transmission mode that were activated may be sent via the at least one uplink sensing resource. The transmission mode may be a normal transmission mode or a pre-equalized transmission mode.

The indication may indicate sensing signal power control parameters, and wherein the sensing signal power control parameters may include a power offset value or a path loss compensation factor. The processor may be configured to send the sensing signal based on the sensing signal power control parameters.

The configuration information may indicate a sensing signal time interval, a frequency domain density, or sensing signal transmit power control parameters. The processor may be configured to send the sensing signal using the sensing signal time interval, the frequency domain density, or the sensing signal transmit power control parameters indicated by the configuration information.

The processor may be configured to send the sensing signal using the pre-equalized transmission mode by applying a pre-equalizer (PEQ) to the sensing signal.

The processor may be configured to determine the pre-equalizer based on a reference channel estimate.

The processor may be configured to receive a signal by the network to use a pre-equalizer from a set of quantized pre-equalizers configured by the network.

The processor may be configured to generate the pre-equalizer using an artificial intelligence (AI) or machine learning (ML) model.

The sensing signal may include an uplink sounding reference signal (SRS).

The processor may be configured to receive a downlink sensing synchronization reference signal from a transmission/reception point (TRP) to align time synchronization with other WTRUs in a sensing group.

The processor may be configured to send one or more additional sensing signals via at least one additional uplink sensing resource among the one or more sensing resources using at least one of an adjusted sensing signal time interval, an adjusted sensing signal frequency domain density, or an adjusted sensing signal transmit power control parameters.

The processor may be configured to receive a message from the network that indicates the adjusted sensing signal time interval, the adjusted sensing signal frequency domain density, or the adjusted sensing signal transmit power control parameters.

The sensing node selection feedback may include a received signal strength indicator (RSSI) associated with one or more antenna ports of the WTRU, a position of the WTRU, channel state information (CSI), or an indication of a preferred transmission mode of the WTRU.

The indication that assigns the WTRU to the sensing group may include a sensing radio network temporary identifier (SEN-RNTI).

A method may be implemented by a wireless transmit/receive unit (WTRU), including receiving an indication from a network to perform measurements associated with uplink sensing, determining sensing node selection feedback based on the indication, transmitting the sensing node selection feedback to the network, and receiving an indication from the network that assigns the WTRU to a sensing group. Configuration information associated with uplink sensing may be received. The configuration information may include an indication of a plurality of sensing resources, a plurality of parameters, and an indication of a transmission mode. An indication to activate at least one uplink sensing resource among the plurality of sensing resources and a set of sensing signal parameters from the plurality of parameters may be received. The indication may indicate the transmission mode. A sensing signal, the set of sensing signal parameters from the plurality of parameters, and the transmission mode that were activated may be sent via the at least one uplink sensing resource. The transmission mode may be a normal transmission mode or a pre-equalized transmission mode.

The method may include the sensing signal based on sensing signal power control parameters, wherein the indication indicates sensing signal power control parameters, and wherein the sensing signal power control parameters may include a power offset value or a path loss compensation factor.

The configuration information may indicate a sensing signal time interval, a frequency domain density, or sensing signal transmit power control parameters. The method may include sending the sensing signal using the sensing signal time interval, the frequency domain density, or sensing signal transmit power control parameters indicated by the configuration information. The method may include sending the sensing signal using the pre-equalized

transmission mode by applying a pre-equalizer (PEQ) to the sensing signal, determining the pre-equalizer based on a reference channel estimate, receiving a signal from the network to use a pre-equalizer from a set of quantized pre-equalizers configured by the network, or generating the pre-equalizer using an artificial intelligence (AI) or machine learning (ML) model.

The method may include sending one or more additional sensing signals via at least one additional uplink sensing resource among the one or more sensing resources using at least one of an adjusted sensing signal time interval, an adjusted sensing signal frequency domain density, or an adjusted sensing signal transmit power control parameters, or receiving a message from the network that indicates the adjusted sensing signal time interval, the adjusted sensing signal frequency domain density, or the adjusted sensing signal transmit power control parameters.

The sensing node selection feedback may include a received signal strength indicator (RSSI) associated with one or more antenna ports of the WTRU, an indication of a position of the WTRU, channel state information (CSI), or an indication of a preferred transmission mode of the WTRU.

The indication that assigns the WTRU to the sensing group may include a sensing radio network temporary identifier (SEN-RNTI).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustratively depicting an example uplink AI-based sensing system architecture.

FIG. 3 is a diagram illustratively depicting an example AI/ML model architecture for wireless sensing.

FIGS. 4A and 4B are diagrams illustratively depicting an example of UE procedures of uplink AI-based sensing, which includes steps, such as, sensing node selection feedback, sensing configuration, activation, sensing signal transmission and etc.,

FIG. 5 is a diagram illustratively depicting an example method for dataset preparation using Sionna Ray Tracing.

FIG. 6 is a diagram illustratively depicting a histogram of number of timesteps per trajectory in Dataset #1 with only walking activity.

FIG. 7 is a diagram illustratively depicting an example trajectory of human from Dataset #2 with all four activities.

FIG. 8 is a diagram illustratively depicting a histogram of horizontal positioning error.

FIG. 9 is a diagram illustratively depicting a cumulative distribution function of horizontal positioning error.

FIG. 10 is a diagram illustratively depicting positioning performance on Test Trajectory #461 and Trajectory #464 from Dataset #1 with only walking activities.

FIG. 11 is a diagram illustratively positioning performance on Test Trajectory #783 and Trajectory #795 from Dataset #2 with all four activities.

FIG. 12 is a diagram illustratively depicting an example downlink AI-based sensing system architecture.

FIGS. 13A and 13B are diagrams illustratively depicting an example of UE procedures of downlink AI-based sensing.

### DETAILED DESCRIPTION

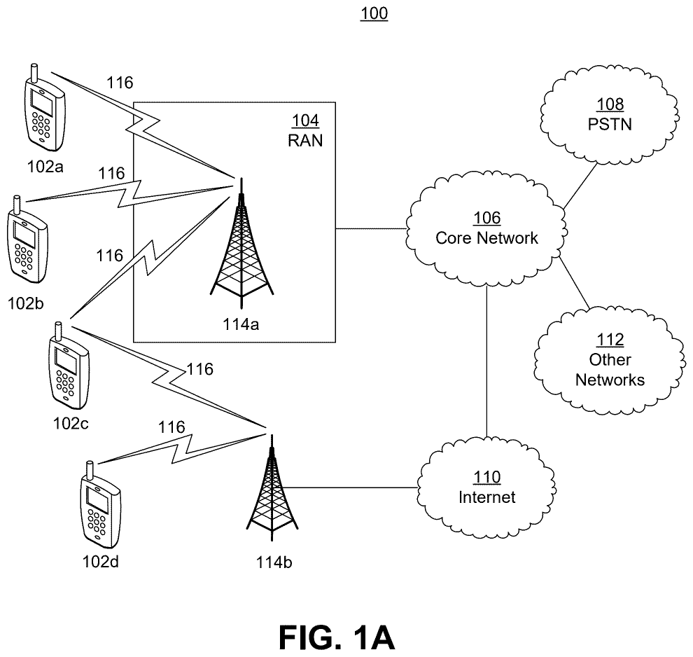

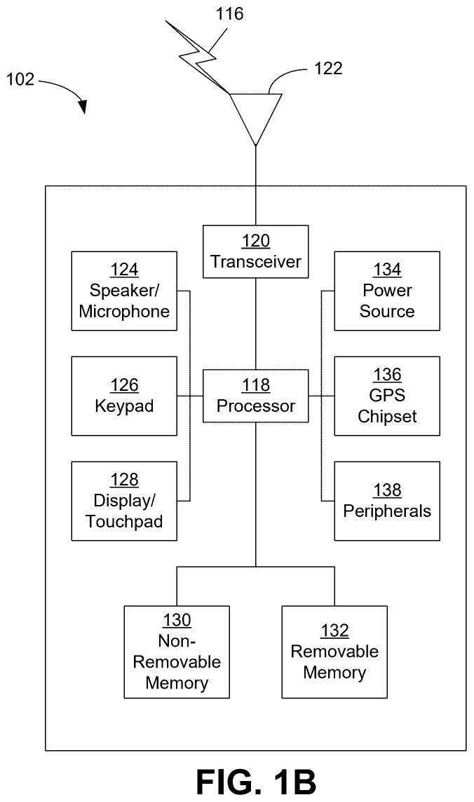

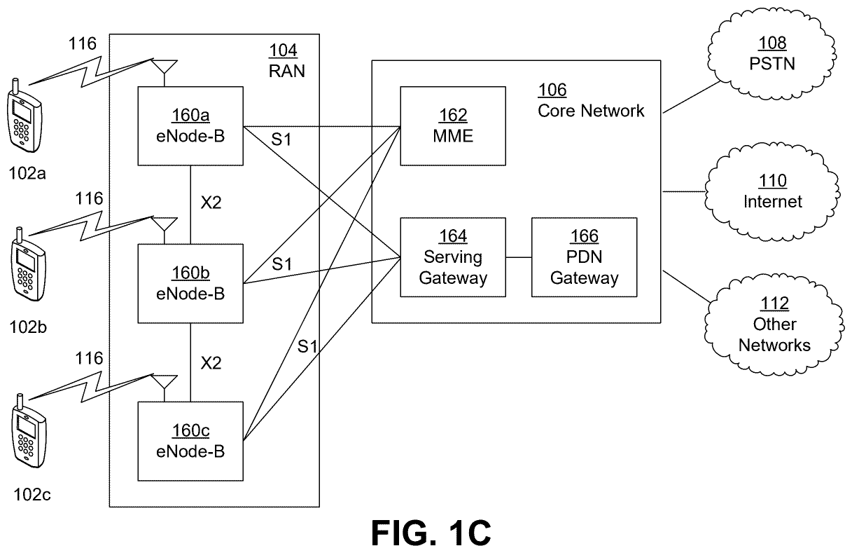

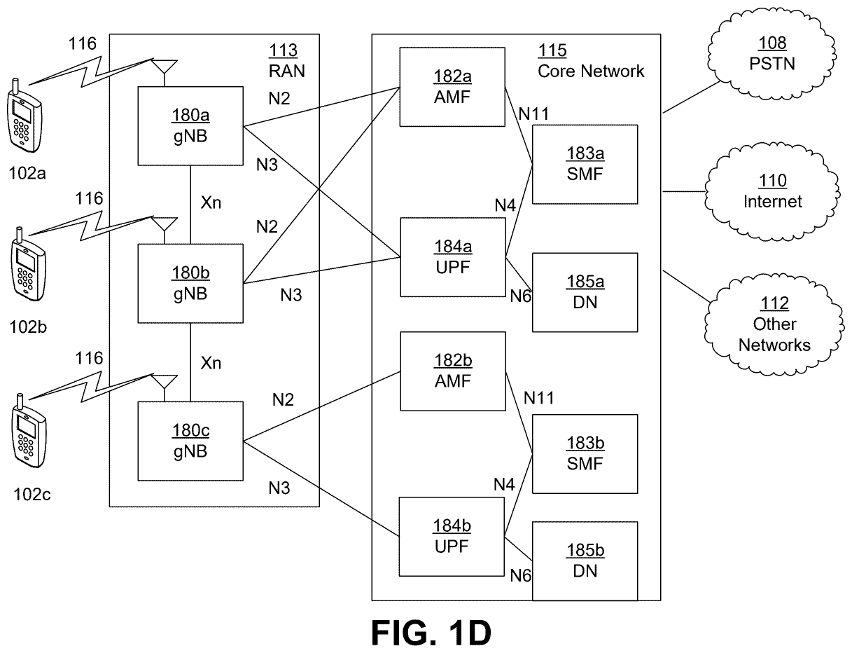

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods described herein may utilize artificial intelligence (AI) and machine learning (ML) models for sensing, and may include utilizing a wireless transmit/receive unit (WTRU) to perform sensing signal transmission and/or sensing signal measurement reporting to enable and/or support sensing.

A supervised learning approach may involve learning a function that maps an input to an output based on labeled training data, wherein each training example may be a pair consisting of an input and a corresponding output. In another example, an unsupervised learning approach may involve detecting patterns in data without pre-existing labels. In another example, a reinforcement learning approach may involve performing a sequence of actions in an environment to maximize a cumulative reward.

ML algorithms may be applied using a combination or interpolation of the above-mentioned approaches. For example, a semi-supervised learning approach may utilize a combination of a small amount of labeled data with a large amount of unlabeled data during training. In this regard, semi-supervised learning falls between unsupervised learning (e.g., with no labeled training data) and supervised learning (e.g., with only labeled training data).

Deep learning may refer to a class of ML algorithms that utilize artificial neural networks, specifically, deep neural networks (DNNs), which may be loosely inspired by biological systems. DNNs may be a special class of ML models inspired by the human brain, wherein an input may be linearly transformed and passed through a non-linear activation function multiple times. DNNs may consist of multiple layers, where each layer consists of a linear transformation and a given non-linear activation function. DNNs may be trained using training data via a back-propagation algorithm.

Recently, DNNs have demonstrated state-of-the-art performance in a variety of domains (e.g., speech, vision, natural language, wireless communication, and/or other applications) and across various ML settings (e.g., supervised, unsupervised, and/or semi-supervised learning).

Wireless sensing technologies may aim at acquiring information about a remote object and/or environment and its characteristics. Perception data obtained via wireless sensing of an object and/or its surroundings may be utilized for analysis to obtain meaningful information about the object and/or environment and its characteristics.

Radio detection and ranging (radar) may be a widely used wireless sensing technology that utilizes radio waves to determine distance (e.g., range), angle, and/or instantaneous linear velocity of objects. Other sensing technologies may include non-radio frequency (RF) sensors that may be used in various applications (e.g., time-of-flight (ToF) cameras, accelerometers, gyroscopes, and/or lidar).

Integrated sensing and communication in a fifth-generation (5G) and/or sixth-generation (6G) system may provide sensing capabilities sharing the same wireless communication system and/or infrastructure as used for communication. The sensing information may be derived from RF-based and/or non-RF-based information.

In general, integrated sensing and communication may involve scenarios of communication-assisted sensing, wherein a wireless communication system may provide sensing services, and/or sensing-assisted communication, wherein sensing information related to a communication channel and/or environment may be utilized to improve the communication service of the 5G and/or 6G system (e.g., sensing information may be used to assist radio resource management, interference mitigation, beam management, mobility, and/or other enhancements), and enable a broad range of new use cases (e.g., object detection and tracking, digital twin, e-Health monitoring, connected vehicles).

The Third Generation Partnership Project (3GPP) Technical Specification Group (TSG) Service and System Aspects (SA) completed a study item focusing on how 5G may enable sensing capabilities, examining different use cases where sensing services may be needed. The study addressed new requirements in different areas (e.g., intruder detection, monitoring, tracking, collision avoidance, and/or other applications) and described several use cases. Based on the conclusions of this study, 3GPP launched a work item aimed at specifying 5G service requirements to support 5G wireless sensing.

Additionally, and/or alternatively, existing channel models in 3GPP Technical Report (TR) 38.901 is modelled for communication, but not modelled for sensing, particularly as they may not address target modeling, sensing, background environment modeling, and/or differentiation from targets. Motivated by the importance of establishing a solid channel modeling framework to enable evaluation of sensing techniques for the use cases identified in TR 22.837, 3GPP TSG Radio Access Network (RAN) initiated a study item addressing the gaps and/or limitations in the channel model in 3GPP TR 38.901 to enable evaluation of sensing techniques.

Traditional radar-like wireless sensing techniques may struggle in non-line-of-sight (NLOS) environments due to significant signal attenuation from obstacles and phase distortions caused by multipath interference. The reliance on line-of-sight (LOS) reflections for precise range and Doppler estimation may be disrupted, and indirect reflections may reduce Doppler shift clarity, affecting velocity estimation. In cluttered environments, high false alarms from random reflections and reduced spatial resolution may make it difficult to differentiate closely spaced objects. Multiple reflections may create ghost targets, complicating object localization and increasing phantom detections. Therefore, it may be desirable to develop wireless sensing solutions to address the aforementioned problems.

One approach to address the aforementioned problems may involve AI and ML-based sensing in the uplink. The WTRU may perform procedures for AI-based sensing in the uplink, as described in further detail herein below, where the network (NW) may refer to any node in the network (e.g., a gNB, another WTRU in sidelink communication, and/or WTRU-to-WTRU direct communication). The WTRU may receive signaling from the NW to perform measurements for sensing node selection. The WTRU may perform measurements (e.g., channel state information reference signals (CSI-RS) and/or other reference signals). The WTRU may measure received power from antenna ports of transmission and reception points (TRPs) that may be used as sensing signal receivers during the actual sensing stage. The WTRU may construct sensing node selection feedback and/or transmit it to the NW. The sensing node selection feedback may include measured received signal strength indicator (RSSI) for each antenna port to the NW, WTRU positioning, and/or CSI, and/or other relevant information. The WTRU may transmit its preference of sensing signals transmission mode to the NW.

The WTRU may receive signaling from the NW that configures a group of WTRUs to perform sensing signal transmission. The configuration may include a sensing group identifier (ID), WTRU IDs in the group, and/or an assigned sensing radio network temporary identifier (SEN-RNTI) that identifies the group. The SEN-RNTI may allow the NW to use group-common downlink control information (DCI) signaling for the WTRUs. The WTRU may receive downlink (DL) sensing synchronization reference signals transmitted from an indicated TRP antenna port so that all WTRUs involved in the same sensing task may have known time alignment. The WTRU may receive a sensing transmission configuration message from the NW. The configuration message may include configuration of multiple sensing resources and sensing signal parameters (e.g., RBs to be used for sensing, sensing signal density in time and/or frequency domain, sensing signal sequence length, and/or other parameters) in the uplink for the WTRU to perform sensing signal transmission. The configuration message may further include configuration of uplink sensing signal transmission, which may include an indication of a transmission mode (e.g., normal transmission and/or pre-equalized transmission modes) and/or uplink sensing signal transmission power control parameters. The configuration message may be a radio resource control (RRC) message transmitted from the NW.

The WTRU may receive a command from the NW to activate one or more uplink sensing resources and sensing signal parameters among the configured sensing resources and parameters for the WTRU to use for sensing signal transmission. The WTRU may receive the command through DCI and/or medium access control-control element (MAC-CE). The amount of uplink sensing resources and sensing signal parameters may depend on the sensing application requirements. The WTRU may receive DCI and/or MAC-CE from the NW indicating a transmission mode and/or activation of one set of configured sensing signal power control parameters. The WTRU may transmit the sensing signal according to the activated and/or configured settings. The activated and/or configured settings may include sensing resources, time intervals of the sensing signal, and/or frequency density of the sensing signal. The WTRU may set the transmit power of its sensing signal according to the uplink transmit power control parameters configured and/or signaled by the NW. The WTRU may perform normal transmission and/or pre-equalized transmission of the sensing signal according to the transmission mode signaling from the NW.

In a normal transmission mode, when the WTRU is configured to perform normal transmission of the sensing signal, the uplink signal may be denoted as:

$$x = s . \qquad [ Equation 1 ]$$

In a pre-equalization mode, the WTRU may receive signaling from the NW to use one of the pre-equalization modes. When the WTRU applies a pre-equalizer (PEQ) to its sensing signal transmission, the pre-equalized uplink sensing signal may become (or may be given by:

$$x = s \cdot PEQ . \qquad [ Equation 2 ]$$

In a first pre-equalization mode, the WTRU may calculate its own pre-equalizer. For example, the WTRU may use knowledge of a reference channel estimate (Href) to calculate a pre-equalizer for sensing transmission. In a second pre-equalization mode, the WTRU may use a pre-equalizer signaled by the NW. The WTRU may receive configuration of a set of quantized pre-equalizers (e.g., {PEQ₁, PEQ₂, . . . , PEQ_{N}}) from the NW. The WTRU may receive signaling from the NW to use one of the configured pre-equalizers (e.g., PEQᵢ,). In a third pre-equalization mode, the WTRU may use an AI and/or ML model to learn a pre-equalizer PEQ for its sensing signal transmission.

The WTRU may receive a command from the NW to adjust sensing signal time interval (periodicity), frequency domain density, sensing resource, sensing signal transmission power control parameters, and/or other parameters based on sensing performance and/or dynamic situations during sensing.

The NW may also perform additional signaling procedures. The NW may send a message to the WTRU instructing it to perform measurements for sensing node selection. The NW may receive sensing node selection measurements and preference of transmission mode of sensing signals from the WTRU and/or may use these measurements and feedback to determine and/or indicate which antenna port to use for sensing synchronization. The NW may transmit downlink sensing synchronization reference signals from an indicated TRP antenna port. The NW may configure a group of WTRUs to perform sensing signal transmission and/or may use group-common signaling for the WTRUs.

The NW transmits configuration message to the WTRU which configures multiple sensing resources and sensing signal parameters (e.g., RBs to be used for sensing, frequency domain, sensing signal density, sensing signal sequence length, and/or other parameters) in the uplink for the WTRU to perform sensing signal transmission. The NW may select appropriate sensing resources and parameters among sensing resources and parameters configured for the WTRU in the uplink based on sensing application requirements. The NW may use DCI and/or MAC-CE to activate one or more uplink sensing resources and parameters for the WTRU to use. The NW may configure multiple transmission modes and multiple sets of uplink sensing signal power control parameters for each sensing application. The NW may use DCI and/or MAC-CE to indicate to the WTRU which transmission mode and which set of sensing signal power control parameters to use. The NW may receive uplink sensing signals and/or may generate a baseline channel estimate (Href) for the sensing environment without the sensing object. The NW may receive uplink sensing signals and/or may calculate channel state information (CSI) for the sensing environment, presumably with the sensing object. The NW may perform pre-processing of received sensing signals to produce input features.

The input features are fed into an AI/ML model trained for wireless sensing. The AI/ML model predicts/outputs the sensing results through the pre-processed input feature. Sensing results may include object/target detection, and/or activity of detected object/target.

If moving object detection is determined to be false, channel measurement data may be collected and/or stored to update Href. The dataset may be collected and/or stored with timestamps to balance robustness and/or performance. The NW may use RF digital twins and/or Sionna ray tracing to generate a ground truth label and/or dataset for sensing of the target object. As additional Href data is collected over time, the database of Href may be continuously updated. The updated database may then serve as input to the Sionna ray tracing tool, which may use the new data to refine and/or enhance the RF digital twin model and/or environment. Based on sensing performance and/or dynamic situations during sensing, the NW may adjust the uplink sensing signal time interval (i.e., periodicity), frequency domain density, sensing resource, sensing signal transmission mode, sensing signal transmission power, and/or other parameters and/or may signal the change to the WTRU. The NW may switch between different sensing detection modes.

In some examples, a wireless transmit/receive unit (WTRU) may perform procedures for artificial intelligence (AI) and/or machine learning (ML)-based sensing in the downlink. A network (NW) may refer to any node in the network (e.g., a gNodeB (gNB), another WTRU (e.g., sidelink, WTRU-to-WTRU direct communication), and/or other network elements).

The WTRU may receive signaling from the NW to perform measurement for sensing node selection. The WTRU may measure the received power from antenna ports of transmission/reception points (TRPs) that are used as sensing signal transmitters. The WTRU may construct a sensing node selection feedback and transmit it to the NW. The sensing node selection feedback may include, but may not be limited to, measured received signal strength indicator (RSSI) for each antenna port to the NW, WTRU positioning, and/or channel state information (CSI). The WTRU may receive signaling from the NW that configures a group of WTRUs to perform sensing measurement feedback. The configuration may include, but may not be limited to, a sensing group identifier (ID), WTRU IDs in the group, and an assigned sensing radio network temporary identifier (SEN-RNTI) that identifies the group. The SEN-RNTI may allow the NW to use group-common downlink control information (DCI) signaling for the WTRUS.

The WTRU may receive a sensing measurement configuration message from the NW. The configuration message may be a radio resource control (RRC) message transmitted from the NW. The configuration message may include, but may not be limited to, configuration of multiple sensing resources and parameters (e.g., sensing signal density in time domain, frequency domain, sensing signal sequence length, and/or index) in the downlink for the WTRU to perform sensing measurement and/or reporting. The configuration message may further include configuration of the WTRU sensing measurement feedback format and/or CSI compression mechanism for sensing purposes. The WTRU may receive, from the NW, a command to activate one or more downlink sensing resources among the configured sensing resources for the WTRU to measure the received sensing signals. The WTRU may receive the command through DCI and/or medium access control (MAC) control element (MAC-CE). The amount of downlink sensing resources may depend on the requirements of the corresponding sensing application.

At the sensing initialization stage, the WTRU may receive and measure downlink sensing signals and generate the baseline CSI for the sensing environment without the sensing object. The WTRU may report the baseline CSI to the NW. During the active sensing stage, the WTRU may receive and measure downlink sensing signals. The WTRU may construct a sensing measurement report and transmit it to the NW. The WTRU may be configured to generate CSI feedback based on the measured downlink sensing signals for the sensing environment with a potential sensing object and/or report it to the NW depending on the sensing application. The WTRU may use an ML-based CSI compression mechanism model to include the generated CSI in the sensing report if the WTRU is configured to do so.

The WTRU may be configured to generate sensing statistics and/or results based on the measured downlink sensing signals for the sensing environment with a potential sensing object during the active sensing stage and/or report them to the NW depending on the sensing application. The WTRU may process the sensing signal measurement locally, perform AI/ML model inference on the measured sensing signals, and/or produce the sensing statistics and/or results locally. The WTRU may include the generated CSI and/or the generated sensing statistics and/or results in the sensing report depending on the sensing application. The WTRU may receive a command from the NW to adjust the time interval, frequency domain density, other sensing parameters and/or sensing resource of the sensing signals for the WTRU to measure, based on the sensing performance and/or dynamic situations during the sensing.

From the NW side, additional operations may be performed. The NW may send a message to the WTRU, which signals the WTRU to perform measurement for sensing node selection. The NW may receive sensing node selection measurements from the WTRU. The NW may use these measurements to determine and/or indicate which antenna port to use for sensing synchronization. The NW may transmit downlink sensing synchronization reference signals from an indicated TRP antenna port. The NW may configure a group of WTRUs to perform sensing signal measurement and/or reporting and may use group-common signaling for the WTRUs.

Based on the requirements of sensing applications, the NW may select appropriate sensing resources and parameters among sensing resources and parameters configured for the WTRU in the downlink. The NW may use DCI and/or MAC-CE to activate one or more downlink sensing resources and parameters for the WTRU to use for measurement. The NW may receive sensing reports from the WTRU for the sensing environment without the sensing object and may generate the baseline CSI data for the sensing environment without the sensing object. The NW may perform pre-processing of the received sensing measurement report.

The input features are fed into an AI/ML model trained for wireless sensing. The AI/ML model predicts/outputs the sensing results through the pre-processed input feature. Sensing results may include object/target detection, and activity of detected object/target, and etc.

When a moving object detection result is false, the dataset may be collected and/or stored with timestamps to balance robustness and/or performance, and the baseline CSI (Href) may be updated. The NW may use radio frequency (RF) digital twins and/or Sionna raytracing to generate the ground truth label and/or dataset for sensing the target object. As additional Href data may be collected over time, the database of Href may be continuously updated. The updated database may then serve as input to the Sionna raytracing tool, which may use the new data to refine and/or enhance the RF digital twin model and/or environment.

Based on the sensing performance and/or dynamic situations during the sensing, the NW may adjust the downlink sensing signal time interval (e.g., periodicity), frequency domain density, sensing resource, sensing signal transmission power, and/or other parameters, and may signal the change to the WTRU. The NW may switch between different sensing detection modes.

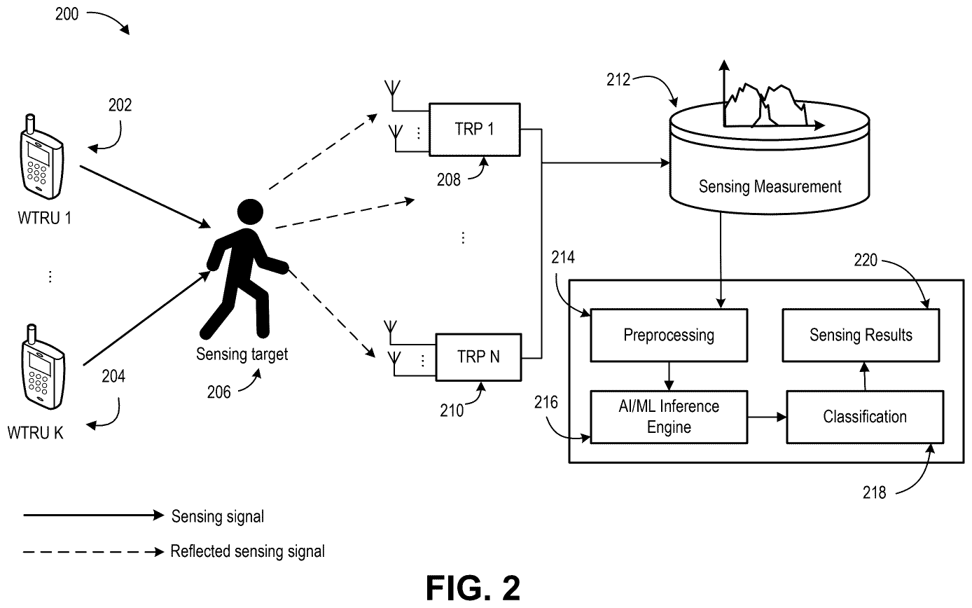

Referring now to FIG. 2, an example uplink AI-based sensing system architecture 200 is illustratively depicted. In the uplink sensing scenario, at 202, a wireless transmit/receive unit (WTRU1) may transmit sensing signals. The sensing signal in the uplink may be a newly defined reference signal for sensing or may reuse an existing uplink sounding reference signal (SRS). At 204, a WTRU_k may also transmit sensing signals, which may interact with the surroundings (e.g., sensing signals are blocked by, reflected by and reflected off walls, floors, and/or sensing objects).

A sensing target 206 may be sensed, and one one or more receivers (e.g., transmission/reception points (TRPs) or gNodeBs (gNBs)) may receive the transmitted sensing signals and perform sensing measurements. The sensing measurements may include, for example, channel state information (CSI). Sensing measurement from multiple receivers At 212, an AI-based sensing processor in the network may perform preprocessing, at 216, AI/machine learning (ML) inference (including feature extraction) may be performed, at 218 classification may be performed to produce sensing results at 220.

At 214 the preprocessing step may involve transforming the sensing measurement to match the AI/ML model's input shape, range, and/or statistical characteristics. The preprocessing may include, for example, calibration, normalization, and/or amplitude/phase correction. At 216, the AI/ML inference engine may process the preprocessed sensing measurement as input to produce explicit sensing-related information, which may include, for example, an object/target presence probability, a location/heading/speed of a detected object/target relative to a reference anchor, a shape/characteristic of the detected object/target, and/or activity/health-related statistics and/or information if the detected object/target is a sensing object of interest (e.g., a human, a car, an autonomous mobile robot (AMR), an automated guided vehicle (AGV), and/or an unmanned aerial vehicle (UAV)).

At 218, in the classification step, the AI-based sensing processor may apply post-processing to the AI/ML inference engine's output to determine classification results. For example, at 216, the AI-based sensing processor may determine whether an object/target is present based on the object/target presence probability. At 218, the AI-based sensing processor may determine the activity of a detected object/target based on activity/health-related statistics and/or information. At 220, the AI-based sensing processor may aggregate the aforementioned sensing results and send them to the next entity or node in the sensing task flow for further processing. The entity or node may be a sensing function in a core network and/or a radio access network (RAN). The next entity or node may depend on the sensing service invocation and the requirements of the corresponding sensing application/task.

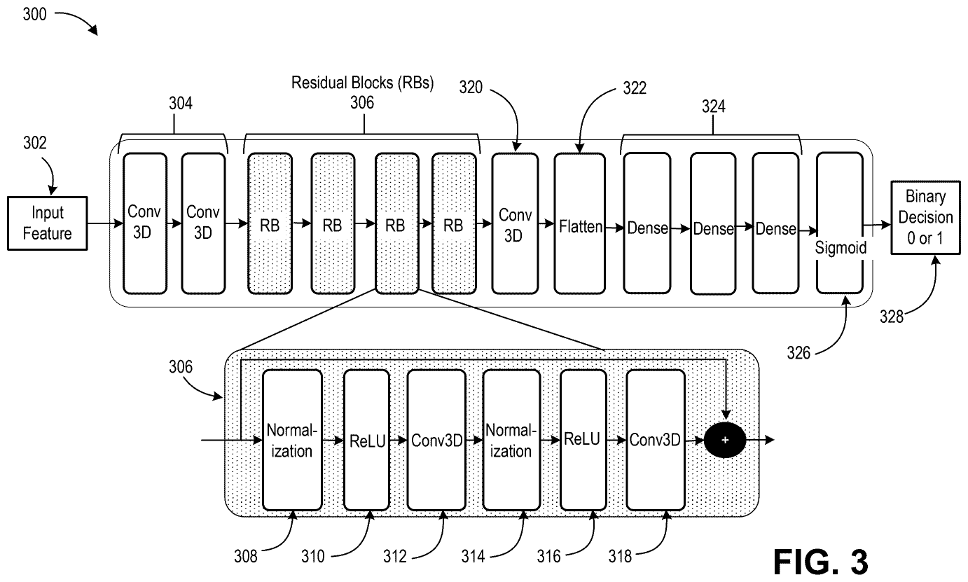

Referring now to FIG. 3, an example AI/ML model architecture 300 for wireless sensing is illustratively depicted. At 302, an input feature may be provided to the AI/ML model. At 304, a first convolutional 3D (Conv3D) layer may process the input feature, followed by another Conv3D layer. At 306, a residual block may be applied to enhance feature extraction and gradient flow.

Within the residual block 306, at 308, a normalization operation may be performed. At 310, a ReLU activation function may be applied. At 312, a Conv3D layer may process the feature representations. At 314, another normalization operation may be performed. At 316, another ReLU activation function may be applied. At 318, another Conv3D layer may be applied before exiting the residual block.

At 320, following the last residual block 306, an additional Conv3D layer may be applied to further refine the extracted features. At 322, a flattening operation may be performed to convert multi-dimensional feature maps into a one-dimensional representation. At 324, one or more dense layers may be applied for the linear combination of features from the previous layers. At 326, a sigmoid activation function may be applied to limit the output values to the range between 0 and 1. At 328, a binary decision may be generated, where decision 0 may indicate that the object and/or target is absent, and decision 1 may indicate that the object and/or target is present.

The AI/ML process and/or system may include multiple stages. The multiple stages may include, but may not be limited to, one or more of input data, pre-processing, post-processing, output data, and/or training. The AI/ML process and/or system may be applied for wireless sensing.

An input data stage may include, but may not be limited to, received sensing signal resource elements (REs) (e.g., sounding reference signal (SRS) and/or other uplink reference signals), known pilot sequences of the sensing signal (e.g., SRS pilots), reference signal received power (RSRP), and/or noise power estimates.

A preprocessing stage at the NW may include, but may not be limited to, extraction of the received sensing signal REs, division of the received sensing signal REs by the known pilot sequence of the sensing signal, and/or multiplication of the received sensing signal REs by the conjugate of the known pilot sequence of the sensing signal. The preprocessing stage may further include applying an interpolation and/or a two-dimensional filtering to the received and/or pre-processed sensing signal REs. Additionally, and/or alternatively, the preprocessing stage may involve estimating the uplink channel Ĥ (e.g., through the received sensing signal), subtracting the baseline/reference channel H_{ref} (e.g., the uplink channel for the sensing environment without the sensing object) from the estimated uplink channel (e.g., Ĥ−H_{ref}), reshaping the input data shape, and/or performing normalization to the input data. Examples of normalization may include, but may not be limited to,

$$\frac{\hat{H} - {H}_{ref}}{c} and / or \frac{\hat{H}}{c} ,$$

where c may be a normalization scalar. The preprocessing stage may further include concatenation of the real and imaginary parts to obtain a real-valued AI/ML model input feature.

The AI/ML model stage may involve treating the AI/ML-based wireless sensing problem as a binary classification, multi-class and/or multi-label classification, and/or regression problem. The AI/ML model may predict a binary decision for object and/or target detection through wireless sensing (e.g., decision 0 may indicate that the object and/or target is absent, and decision 1 may indicate that the object and/or target is present). The AI/ML model may be constructed using a combination of convolutional neural networks (CNNs) and/or residual networks (ResNets). In particular, the AI/ML model may include convolutional layers, concatenation layers, normalization layers, ReLU activation layers, residual skip connections, and/or sigmoid activation layers. The AI/ML model may predict and/or output a binary decision through the pre-processed input feature. The input feature may include four dimensions as a representation of input data corresponding to an antenna and/or spatial domain, a frequency domain, a time domain, and/or real and imaginary parts.

A post-processing stage may include, but may not be limited to, reshaping the AI/ML model output and/or de-normalizing the AI/ML model output. An output data stage may involve generating AI/ML model output, which may include, but may not be limited to, a binary decision for object and/or target detection (e.g., decision 0 may indicate that the object and/or target is absent, and decision 1 may indicate that the object and/or target is present), a multi-class decision for the activity of a detected object and/or target, a multi-class decision for the type of a detected object and/or target (e.g., human, cat, dog, and/or another object), a position of a detected object and/or target (e.g., x, y, and/or z coordinates), and/or a velocity of a detected object and/or target.

A training stage may involve performing training online and/or offline in a supervised manner. Based on the output data, the AI/ML-based wireless sensing problem may be considered as a binary classification problem, a multi-class classification problem (e.g., a multi-label classification problem), and/or a regression problem.

When a WTRU may be configured to perform AI/ML-based sensing, key parameters may be configured by the NW, which may include, but may not be limited to, configuration of a group of WTRUs to perform sensing signal transmission. The configuration may include, but may not be limited to, a sensing group ID, WTRU IDs in the group, and an assigned sensing radio network temporary identifier (SEN-RNTI) that may identify the group. The SEN-RNTI may allow the NW to use group-common downlink control information (DCI) signaling for these WTRUs.

A sensing transmission configuration message may be provided, which may include, but may not be limited to, configuration of multiple sensing resources and sensing signal parameters (e.g., RBs to be used for sensing, time domain interval, frequency domain density, and/or sequence length) in the uplink for the WTRU to perform sensing signal transmission. The configuration of uplink sensing signal transmission may include an indication of a transmission mode (e.g., normal transmission and/or pre-equalized transmission modes) and/or uplink sensing signal transmission power control parameters. The configuration message may be a radio resource control (RRC) message transmitted from the NW. Additionally, and/or alternatively, a baseline channel H_{ref} for the sensing environment without the sensing object may be established.

Signaling may include signaling transmitted from the NW to the WTRU for the WTRU to perform measurement for sensing node selection. Signaling may include sensing node selection feedback transmitted from the WTRU to the NW. Signaling may include signaling transmitted from the NW to the WTRU for the WTRU to perform sensing signal transmission. Signaling may include downlink sensing synchronization reference signals transmitted from an indicated transmission and reception point (TRP) antenna port to the WTRU.

Signaling may include a command transmitted from the NW to the WTRU to activate one or more uplink sensing resources and parameters among the configured sensing resources for the WTRU to use for sensing signal transmission. The WTRU may receive the command through DCI and/or a medium access control control element (MAC-CE). Signaling may include signaling transmitted from the NW to the WTRU indicating a transmission mode and/or activating one set of the configured sensing signal power control parameters.

Signaling may include the sensing signal transmitted from the WTRU to the NW according to the activated and/or configured settings. Signaling may include a command transmitted from the NW to the WTRU for the WTRU to adjust sensing signal time interval, frequency domain density, sensing resource, sensing signal transmission power control, and/or other parameters based on the sensing performance and/or dynamic conditions during sensing.

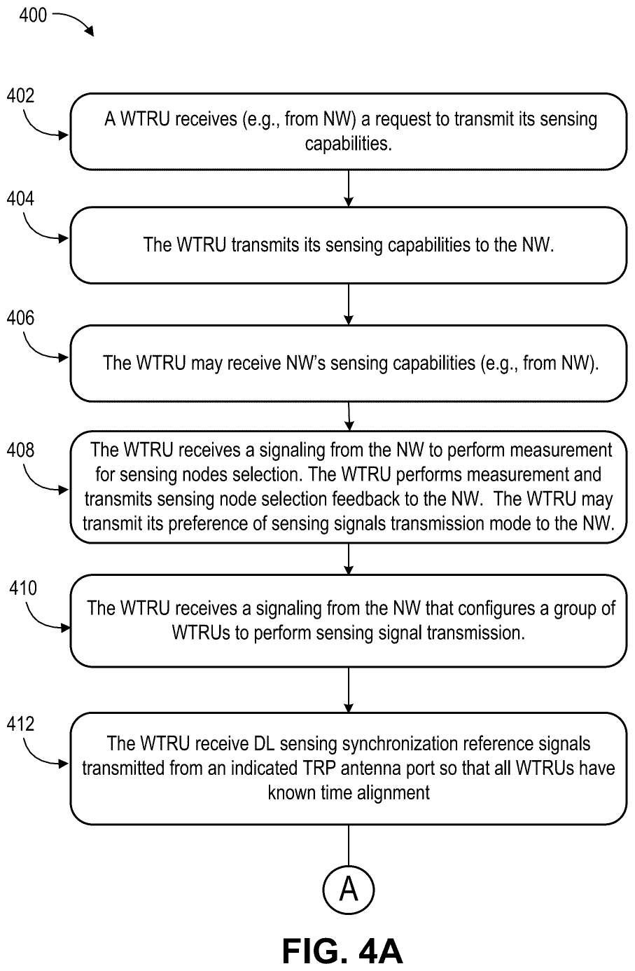

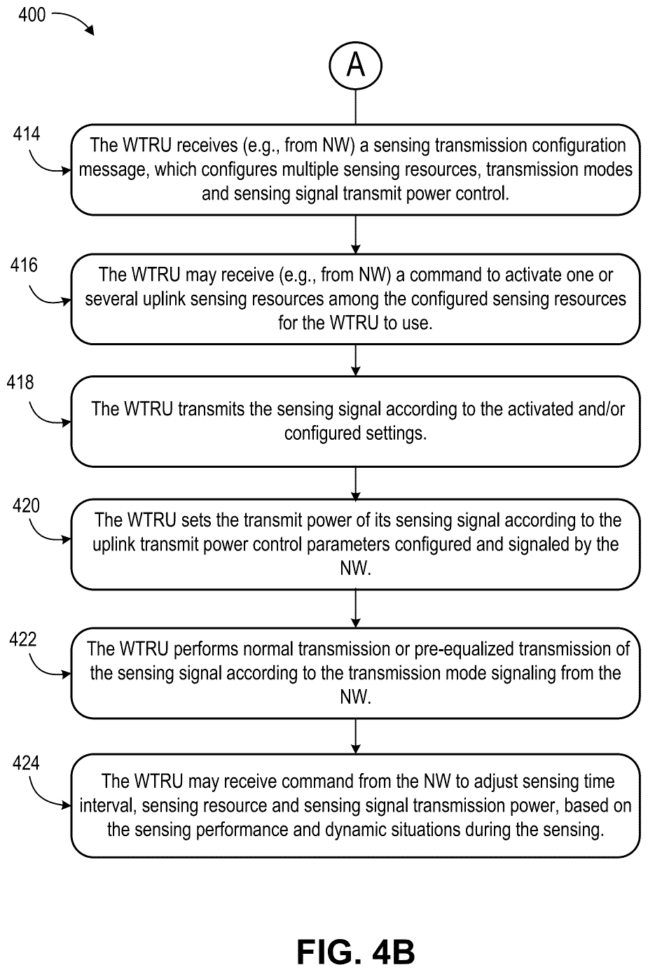

An example method 400 to perform AI-based sensing using a WTRU is illustratively depicted in FIG. 4. The NW may be any node in the network (e.g., a gNB, another WTRU such as in sidelink communication and/or WTRU-to-WTRU direct communication). A WTRU may receive (e.g., from the NW) a request to transmit sensing capabilities. The WTRU may transmit its sensing capabilities to the NW. The capabilities message may indicate one or more of the following: WTRU support for sensing and/or AI/ML-based sensing and/or WTRU hardware and/or radio impairments (e.g., phase noise characteristic, power amplifier characteristic). The WTRU may transmit its capabilities to the NW by means of RRC signaling.

The WTRU may receive (e.g., from the NW) the NW's sensing capabilities. The capabilities message may indicate one or more of the following: NW support for sensing and/or AI/ML-based sensing and/or NW hardware and/or radio impairments (e.g., phase noise characteristic, power amplifier characteristic). The WTRU may receive the NW's capabilities by means of RRC signaling.

The WTRU may receive signaling from the NW to perform measurement for sensing node selection. The WTRU may perform measurement (e.g., CSI-RS and/or other reference signals) and may transmit sensing node selection feedback to the NW. The WTRU may measure received power from antenna ports of TRPs that are used as sensing signal receivers and may report the measured received signal strength indicator (RSSI) for each antenna port to the NW. The sensing node selection feedback may include RSSI, WTRU positioning and/or CSI, and/or other relevant information. The WTRU may transmit its preference of sensing signals transmission mode to the NW.

The WTRU may receive signaling from the gNB that configures a group of WTRUs to perform sensing signal transmission. The configuration may include a sensing group ID, WTRU IDs in the group, and an assigned SEN-RNTI that may identify the group. The SEN-RNTI may allow the NW to use group-common DCI signaling for these WTRUs. The WTRU may receive downlink sensing synchronization reference signals transmitted from an indicated TRP antenna port so that all WTRUs may have known time alignment.

The WTRU may receive (e.g., from the NW) a sensing transmission configuration message. The configuration message may be an RRC message transmitted from the NW and may include configuration of multiple sensing resources and sensing signal parameters (e.g., RBs to be used for sensing, sensing signal density in time and/or frequency domain, and/or sensing signal sequence length) in the uplink for the WTRU to perform sensing signal transmission. The configuration of uplink sensing signal transmission may include an indication of transmission mode (e.g., normal transmission and/or pre-equalized transmission modes) and/or uplink sensing signal transmission power control parameters (e.g., multiple sensing signal power offset values and/or path loss compensation factors for sensing signal power control).

The WTRU may receive a DCI and/or MAC-CE from the NW to activate one or more uplink sensing resources among the configured sensing resources and parameters for the WTRU to use. The parameters and the amount of uplink sensing resources may depend on the requirements of the sensing application. The WTRU may receive a DCI and/or MAC-CE from the NW indicating a transmission mode and/or activating one set of the configured sensing signal power control parameters (e.g., power offset values and/or path loss compensation factors for sensing signal). The WTRU may transmit the sensing signal according to the activated and/or configured settings (e.g., sensing resources, time interval, and/or frequency domain density). The WTRU may set the transmit power of its sensing signal according to the uplink transmit power control parameters configured and/or signaled by the NW.

For example, the transmit power for a sensing signal, may be denoted by

$${P}_{sen} = min ( {P}_{c}^{MAX} , {P}_{0}^{sen} + {α}_{sen} \times PL + {Δ}_{T}^{sen} + {f}_{sen} ) [ dBm ] , where {P}_{c}^{MAX}$$

may be the WTRU's configured maximum transmission power,

$${P}_{0}^{sen}$$

may be the sensing signal power offset, αₛₑₙ may be the path loss compensation factor, PL may be the path loss estimate,

$${Δ}_{T}^{sen}$$

may be the WTRU-specific transmit power control (TPC) command for sensing signal transmission, and fₛₑₙ may be the frequency-dependent sensing signal transmit power adjustment.

The WTRU may perform normal transmission and/or pre-equalized transmission of the sensing signal according to the transmission mode signaling from the NW. The baseline channel for the sensing environment without the sensing object may be used as a reference channel and may be denoted as H_{ref}. For pre-equalized transmission, the WTRU may use knowledge of H_{ref} to calculate a pre-equalizer for sensing transmission. In a time division duplexing (TDD) system, the WTRU may use downlink reference signals to directly estimate H_{ref}. The WTRU may be polled by the NW regarding whether it has its own estimate of H_{ref}. Alternatively, the WTRU may receive H_{ref} from the NW.

When the WTRU may be configured to perform normal transmission of the sensing signal s, the uplink signal may be denoted by x=s. The received signal at the gNB may be given by:

$$y = Hx + n = Hs + n ,$$

where H may be the uplink (sensing) channel between the WTRU and gNB, and n may be the noise at the gNB. By using the (known) sensing signal, the gNB may perform channel estimation and/or equalization as follows:

$$\hat{H} = {ys}^{*} = H {\vert s \vert}^{2} + {ns}^{*} = H + \tilde{n} .$$

The gNB may perform pre-processing to the estimated channel with the reference channel H_{ref}. For example, the input feature to the AI/ML model may be obtained through the following pre-processing:

$$Input Feature = \hat{H} - {H}_{ref} .$$

The WTRU may receive signaling from the NW to use one or more pre-equalization modes. When the WTRU applies a pre-equalizer PEQ to its sensing signal transmission, the pre-equalized uplink sensing signal may become (or be given by) x=s·PEQ.

In Pre-equalization Mode 1, the WTRU may calculate its own pre-equalizer. For example, the WTRU may be configured to perform pre-equalized transmission of the sensing signal s with a pre-equalizer of

$$PEQ = \frac{( 1 - \frac{{H}_{ref}}{H} )}{\vert 1 - \frac{{H}_{ref}}{H} \vert} .$$

Then, the pre-equalized uplink sensing signal may be denoted by

$$x = s \frac{( 1 - \frac{{H}_{ref}}{H} )}{\vert 1 - \frac{{H}_{ref}}{H} \vert} .$$

Here, H may denote the recent (estimated) uplink channel known at the WTRU (e.g., through measurement of CSI-RS, CSI prediction, and/or channel reciprocity), while H_{ref} may denote the reference channel for the sensing environment without the sensing object. The received signal at the gNB may be denoted by:

$$y = Hx + n = Hs \frac{( 1 - \frac{{H}_{ref}}{H} )}{\vert 1 - \frac{{H}_{ref}}{H} \vert} + n ,$$

where H may be the uplink channel between WTRU and gNB, and n may be the noise at the gNB. Using the known sensing signal, the gNB may perform input feature estimation and/or equalization as follows:

$$Input Feature = {ys}^{*} \vert 1 - \frac{{H}_{ref}}{H} \vert = H ( 1 - \frac{{H}_{ref}}{H} ) {\vert s \vert}^{2} + n {s}^{*} \vert 1 - \frac{{H}_{ref}}{H} \vert = \hat{H} - {H}_{ref} ,$$

where the estimated channel may be denoted as

$$\hat{H} = H + n {s}^{*} \vert 1 - \frac{{H}_{ref}}{H} \vert .$$

Hence, the pre-equalization Mode 1 enables the feature extraction and pre-processing at the transmitter, which can reduce the effective noise power at the receiver. Particularly, the noise power is normalized by

$$\vert 1 - \frac{{H}_{ref}}{H} \vert .$$

Thus, Pre-equalization Mode 1 can increase the quality of input features of AI/ML by model (i.e., lower estimation error at the receiver).

In Pre-equalization Mode 2, the WTRU may use a pre-equalizer signaled by the NW. For example, the WTRU may receive configuration of multiple quantized pre-equalizers {PEQ₁, . . . , PEQ_{N},} from the NW, and may be signaled to use one of the configured pre-equalizers PEQᵢ. Then, the pre-equalized uplink sensing signal may be denoted by x=s·PEQᵢ.

In Pre-equalization Mode 3, the WTRU may use AI/ML to learn a pre-equalizer for sensing signal transmission.

The WTRU may receive a command from the NW to adjust sensing signal time interval (e.g. periodicity), frequency domain density, sensing resource, and/or sensing signal transmission power control parameters based on sensing performance and/or dynamic conditions, or the WTRU may autonomously adjust them and signal the change to the NW. The WTRU may alternatively request the NW to adjust these parameters using uplink signaling and/or data channels.

Referring now to FIG. 4, an example method 400 to perform AI-based uplink sensing using a WTRU is illustratively depicted. At 402, the WTRU may receive, for example, from a network (NW), a request to transmit sensing capabilities. At 404, the WTRU may transmit its sensing capabilities to the NW. The capabilities message may indicate one or more of the following: WTRU support for sensing and AI/ML-based sensing, and/or WTRU hardware/radio impairments (e.g., phase noise characteristic and/or power amplifier characteristic). The WTRU may transmit its capabilities to the NW by means of radio resource control (RRC) signaling. At 406, the WTRU may receive, for example, from the NW, the NW's sensing capabilities. The capabilities message may indicate one or more of the following: NW support for sensing and AI/ML-based sensing, and/or NW hardware/radio impairments (e.g., phase noise characteristic and/or power amplifier characteristic). The WTRU may receive the NW's capabilities by means of RRC signaling.

At 408, the WTRU may receive signaling from the NW to perform measurement for sensing node selection. The WTRU may perform measurement, for example, channel state information reference signals (CSI-RS) and/or other reference signals. The WTRU may transmit sensing node selection feedback to the NW. The WTRU may measure received power from antenna ports of transmission reception points (TRPs) that are used as sensing signal receivers and may report the measured received signal strength indicator (RSSI) for each antenna port to the NW. The sensing node selection feedback may include WTRU positioning and/or CSI, and/or other relevant information. The WTRU may transmit its preference of sensing signals transmission mode to the NW. At 410, the WTRU may receive signaling from the NW that configures a group of WTRUs to perform sensing signal transmission. The configuration may include a sensing group identifier (ID), WTRU IDs in the group, and/or an assigned sensing radio network temporary identifier (SEN-RNTI) that identifies the group. The SEN-RNTI may allow the NW to use group-common downlink control information (DCI) signaling for these WTRUs.

At 412, the WTRU may receive downlink (DL) sensing synchronization reference signals transmitted from an indicated TRP antenna port so that all WTRUs may have known time alignment. At 414, the WTRU may receive, for example, from the NW, a sensing transmission configuration message. The configuration message may be an RRC message transmitted from the NW and may include one or more of the following: configuration of multiple sensing resources and sensing signal parameters (e.g., RBs to be used for sensing, sensing signal density in time and/or frequency domain, and/or sensing signal sequence length) in the uplink (UL) for the WTRU to perform sensing signal transmission; and/or configuration of uplink sensing signal transmission, which may include indication of transmission mode (e.g., normal transmission and/or pre-equalized transmission modes) and/or uplink sensing signal transmission power control parameters (e.g., multiple sensing signal power offset values and/or path loss compensation factors for sensing signal power control).

At 416, the WTRU may receive a DCI and/or a medium access control (MAC) control element (MAC-CE) from the NW to activate one or more UL sensing resources among the configured sensing resources for the WTRU to use. The amount of UL sensing resources may depend on the requirements of the sensing application. The WTRU may receive a DCI and/or a MAC-CE from the NW indicating a transmission mode and/or activating one set of the configured sensing signal power control parameters (e.g., power offset values and/or path loss compensation factors for sensing signal). At 418, the WTRU may transmit the sensing signal according to the activated and/or configured settings (e.g., sensing resources, sensing time interval, and/or frequency domain density).

At 420, the WTRU may set the transmit power of its sensing signal according to the UL transmit power control parameters configured and signaled by the NW. For example, the transmit power for sensing signal may be denoted by:

$${P}_{sen} = min ( {P}_{c}^{MAX} , {P}_{0}^{sen} + {α}_{sen} \times PL + {Δ}_{T}^{sen} + {f}_{sen} ) [ dBm ] ,$$

where

$${P}_{c}^{MAX}$$

is the WTRU's configured maximum transmission power,

$${P}_{0}^{sen}$$

is the sensing signal power offset, αₛₑₙ is the path loss compensation factor, PL is the path loss estimate,

$${Δ}_{T}^{sen}$$

is WTRU-specific TPC command for sensing signal transmission, and fₛₑₙ is the frequency-dependent sensing signal transmit power adjustment.

At 422, the WTRU may perform normal transmission or pre-equalized transmission of the sensing signal according to the transmission mode signaling from the NW. The baseline channel for the sensing environment without the sensing object may be used as a reference channel and may be denoted as H_{ref}. For pre-equalized transmission, the WTRU may use the knowledge of H_{ref} to calculate a pre-equalizer for sensing. In a time-division duplexing (TDD) system, the WTRU may use DL reference signals to directly estimate H_{ref}. The WTRU may be polled by the NW if it has its own estimate of H_{ref}. Additionally, and/or alternatively, the WTRU may receive H_{ref} from the NW.

When the WTRU is configured to perform the normal transmission of the sensing signal (e.g., s), the uplink signal can be denoted by x=s. Then, the received signal at the gNB may be written as:

$$y = Hx + n = Hs + n ,$$

where H may be the uplink (sensing) channel between WTRU and gNB, and n may be the noise at the gNB. Then, by using the (known) sensing signal, the gNB may perform the channel estimation (or equalization) as follows:

$$\hat{H} = {ys}^{*} = H {\vert s \vert}^{2} + n {s}^{*} = H + \tilde{n} .$$

Then, the gNB may perform the pre-processing to the estimated channel through the reference channel H_{ref}. For example, the input feature to the AI/ML model may be obtained through the following pre-processing:

$$Input Feature = \hat{H} - {H}_{ref} .$$

As discussed above, the WTRU may receive signaling from the NW to use one or more pre-equalization modes. When the WTRU applies a pre-equalizer PEQ to its sensing signal transmission, the pre-equalized uplink sensing signal may become (or be given by) x=s·PEQ.

In Pre-equalization Mode 1, the WTRU may calculate its own pre-equalizer. For example, the WTRU may be configured to perform pre-equalized transmission of the sensing signal s with a pre-equalizer of

$$PEQ = \frac{( 1 - \frac{{H}_{ref}}{H} )}{\vert 1 - \frac{{H}_{ref}}{H} \vert} .$$

Then, the pre-equalized uplink sensing signal may be denoted by

$$x = s \frac{( 1 - \frac{{H}_{ref}}{H} )}{\vert 1 - \frac{{H}_{ref}}{H} \vert} .$$

Here, H may denote the recent (estimated) uplink channel (e.g., through CSI-RS transmission, CSI prediction, and/or channel reciprocity), while H_{ref} may denote the reference channel for the sensing environment without the sensing object. The received signal at the gNB may be denoted by:

$$y = Hx + n = Hs \frac{( 1 - \frac{{H}_{ref}}{H} )}{\vert 1 - \frac{{H}_{ref}}{H} \vert} + n ,$$

where H may be the uplink channel between WTRU and gNB, and n may be the noise at the gNB. Using the known sensing signal, the gNB may perform input feature estimation and/or equalization as follows:

$$Input Feature = {ys}^{*} \vert 1 - \frac{{H}_{ref}}{H} \vert = H ( 1 - \frac{{H}_{ref}}{H} ) {\vert s \vert}^{2} + {ns}^{*} \vert 1 - \frac{{H}_{ref}}{H} \vert = \hat{H} - {H}_{ref} ,$$

where the estimated channel may be denoted as

$$\hat{H} = H + {ns}^{*} \vert 1 - \frac{{H}_{ref}}{H} \vert .$$

Hence, the pre-equalization Mode 1 enables the feature extraction and pre-processing at the transmitter, which can reduce the effective noise power at the receiver. Particularly, the noise power is normalized by

$$\vert 1 - \frac{{H}_{ref}}{H} \vert .$$

Thus, Pre-equalization Mode 1 can increase the quality of input features of AI/ML model (i.e., lower estimation error at the receiver).

In Pre-equalization Mode 2, the WTRU may use a pre-equalizer signaled by the NW. For example, the WTRU may receive configuration of multiple quantized pre-equalizers {PEQ₁, . . . , PEQ_{N},} from the NW, and may be signaled to use one of the configured pre-equalizers PEQᵢ. Then, the pre-equalized uplink sensing signal may be denoted by x=s·PEQᵢ.

In Pre-equalization Mode 3, the WTRU may use AI/ML to learn a pre-equalizer for sensing signal transmission.

At 424, the WTRU may receive a command from the NW to adjust sensing signal time interval (e.g. periodicity), frequency domain density, sensing resource, and/or sensing signal transmission power control based on the sensing performance and dynamic situations during the sensing, or the WTRU may adjust them autonomously. For example, the WTRU may receive a command from the NW to increase the sensing time interval and/or reduce the sensing signal density in the frequency domain when the moving object detection result becomes False and remains False for a predefined period of time. The WTRU may receive the command through a DCI and/or a MAC-CE. The WTRU may adjust sensing signal time interval (e.g. periodicity), frequency domain density, sensing resource, and/or sensing signal transmission power control autonomously and may signal the change to the NW if the WTRU has knowledge of sensing performance and dynamic situations during the sensing. Alternatively, the WTRU may request the NW to adjust these sensing parameters using UL signaling and/or data channels.

The NW may transmit a sensing capabilities request to the WTRU. The NW may receive the sensing capabilities from the WTRU. The NW may transmit the NW sensing capabilities to the WTRU. The NW may send a message to the WTRU, which may signal the WTRU to perform measurement for sensing node selection. The NW may receive the sensing node selection measurement from the WTRU. The NW may use these measurements to determine and indicate which antenna port to use for sensing synchronization. The NW may transmit downlink sensing synchronization reference signals from an indicated TRP antenna port.

The NW may configure a group of WTRUs to perform sensing signal measurement and reporting. The configuration may indicate a sensing group ID, WTRU IDs in the group, and an assigned SEN-RNTI that identifies the group. The NW may use the SEN-RNTI to scramble the CRC of a particular DCI to send sensing-related signals to this group of WTRUs. The NW may use group-common sensing signaling for these WTRUs to reduce signaling overhead.

Based on the requirements of the sensing application, the NW may select appropriate sensing resources among the sensing resources configured for the WTRU in the downlink. For each sensing application, the NW may use DCI and/or MAC-CE to indicate one set of sensing signal power control parameters for the WTRU to use. The NW may configure multiple power offset values and/or path loss compensation factors for sensing signal power control.

The NW may receive uplink sensing signals and may generate the baseline CSI data for the sensing environment without the sensing object. The NW may receive uplink sensing signals and may calculate the CSI for the sensing environment presumably with the sensing object. The NW may perform pre-processing of the received sensing signals to produce input features as follows:

$$Input Features = \frac{{\hat{H}}_{freq , est} - {H}_{freq , ref}}{{C}_{max}} ∈ [ - 1 , + 1 ]$$

$${C}_{max} = max ( \vert {\hat{H}}_{freq , est} - {H}_{freq , ref} \vert )$$

$$Class 1 : Input Features with Human : \frac{{\hat{H}}_{{freq}_{human} , est} - {H}_{freq , ref}}{{c}_{max}}$$

$$Class 0 : Input Features without Human : \frac{{\hat{H}}_{freq , ref , est} - {H}_{freq , ref}}{{c}_{max}} = \frac{\tilde{n}}{\sqrt{{P}_{T}} {C}_{max}}$$

$${\hat{H}}_{freq , ref , est} = {H}_{freq , ref} + \frac{n {s}^{*}}{\sqrt{{P}_{T}} {\vert s \vert}^{2}} = {H}_{freq , ref} + \frac{\tilde{n}}{\sqrt{{P}_{T}}}$$

Class 1: Feature+Noise
Class 0: Only Noise

When the moving object detection result is false, the NW may collect data to update H_{ref}. The dataset may be collected and stored with timestamps to balance robustness and performance. The NW may use RF digital twins and Sionna raytracing to generate the ground truth label and/or dataset for the sensing of the target object. As additional H_{ref} data are collected over time, the database of H_{ref} may be continuously updated. The updated database may then serve as input to the Sionna raytracing tool, which may use the new data to refine and/or enhance the RF digital twin model and/or environment.

For example, in an indoor environment, differential locations of furniture and/or wall material properties may be trained to match H_{ref} data. When the NW detects a change in the RF digital twin environment, sensing ML models may be triggered to re-train on new channels and/or CIRs generated from the updated RF digital twin environment, such as those created by Sionna Ray Tracing. The history of H_{ref} changes over time may be saved and added to the training dataset so that the sensing and/or its performance may be more robust to sensing environment changes. For example, the sensing environment change may be caused by moving furniture.

Based on the sensing performance and/or dynamic conditions during the sensing process, the NW may adjust the downlink sensing signal time interval, frequency density, sensing resources, sensing signal transmission power, and/or other parameters and may signal the change to the WTRU. The NW may switch between different sensing detection modes. For example, when the moving object detection result becomes false and remains false for a predefined period of time, the NW may decide to increase the sensing time interval and/or reduce the sensing signal density in the frequency domain for downlink sensing transmissions and may signal the change to the WTRU. The NW may change the sensing detection mode to “object detection only.”

Additionally, and/or alternatively, the NW may receive signaling from the WTRU requesting an adjustment to the sensing parameters. The NW may grant and/or reject the request. In the scenarios of sidelink communication, device-to-device (D2D) communication, and vehicle-to-everything (V2X) communication, the procedures of the NW node described above may be performed by a WTRU.

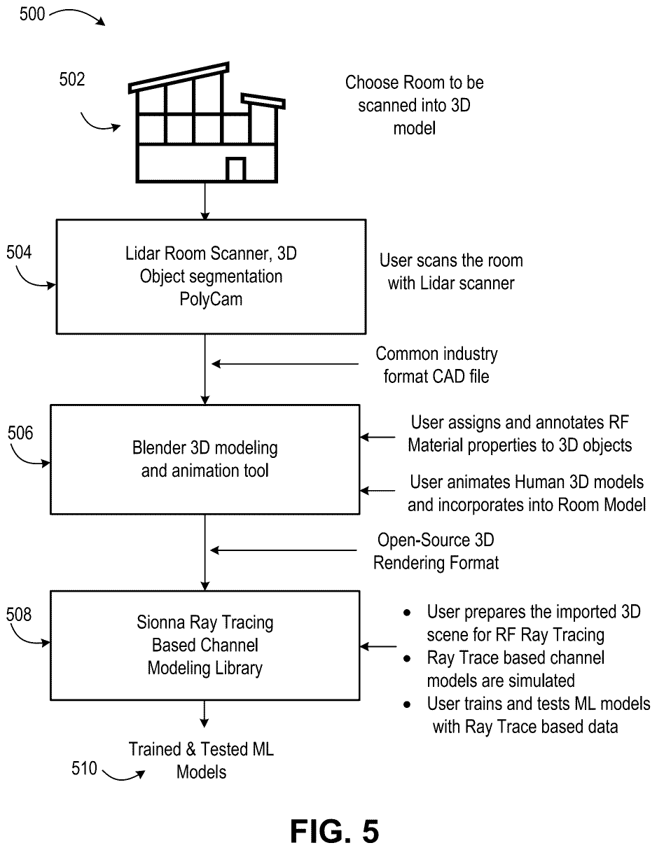

Referring now to FIG. 5, an example method 500 for dataset preparation using Sionna Ray Tracing is illustratively depicted. At 502, a room may be chosen to be scanned into a 3D model. At 504, a Lidar room scanner and/or 3D object segmentation tool, such as PolyCam, may be used to scan the room. PolyCam may run on iPhone models that include Lidar. The scanned data may be exported from PolyCam in Wavefront industry-standard .obj and .mtl file formats and may then be uploaded to a network disk where the files may be accessed from a computer.

At 506, Blender, an open-source 3D modeling and animation tool, may import the room .obj and .mtl files and may render the model in Blender format. Within Blender, the room model may be checked for consistency and/or completeness. If the room model is satisfactory, a user may proceed to identify segmented objects in the room, such as tables, chairs, walls, and/or windows, and may annotate the objects with appropriate radio frequency (RF) electromagnetic (EM) material types. For example, a wall may be assigned the ‘itu_plasterboard’ attribute, and/or a window may be assigned the ‘itu_glass’ attribute. The ‘itu_’ prefix may refer to the International Telecommunication Union (ITU) published catalog of RF EM characteristics of various materials. A user may also incorporate human models into the 3D room model. The human models may also be assigned RF EM material attributes. Blender may be used to animate the human models to perform realistic human activities, such as walking, standing, sitting, and/or falling. Each frame of an animation may constitute a new scene for ray tracing. Blender may determine the global [X, Y, Z] coordinate system for the 3D room model. The same global coordinate system may be used in Sionna to locate transmit and receive antenna locations in the room.

At 508, after preparation of the 3D model is completed in Blender, it may be exported in an open-source rendering format called Mitsuba. Sionna may import the Mitsuba file into a Python object referred to as the scene object. A user may then prepare Sionna for ray tracing-based simulation with the scene object by assigning parameters, including an RF frequency, antenna placement, antenna pattern, a number of bounces to allow for multipath, a number of rays to launch, and/or types of RF rays to use (e.g., line of sight, specular reflection, diffraction, and/or diffuse scattering).

At 510, after ray tracing the RF paths, a user may have Sionna perform EM field calculations to determine the received channel impulse response (CIR). The channel frequency response (CFR) may also be calculated based on orthogonal frequency-division multiplexing (OFDM) waveform characteristics provided by a user.

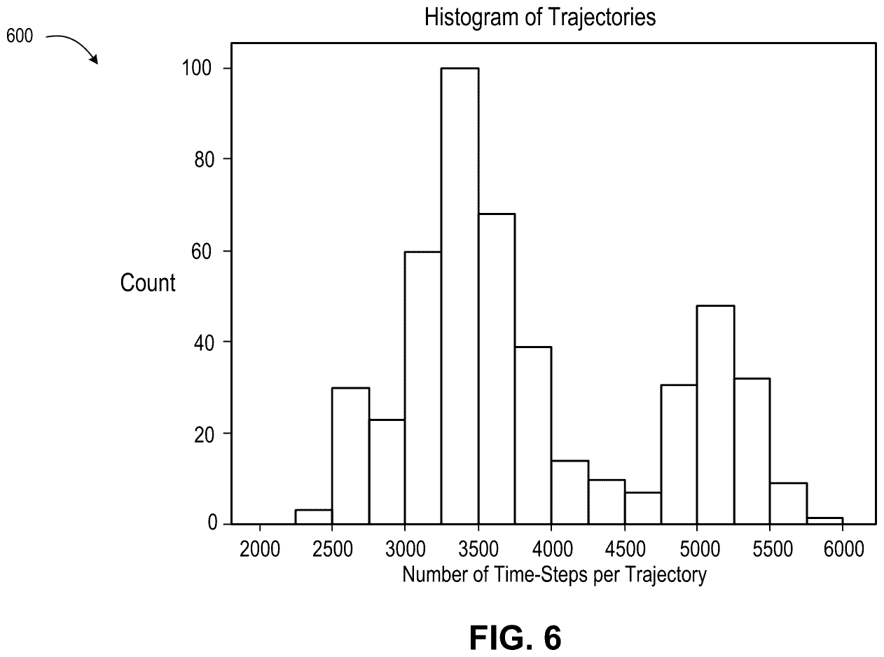

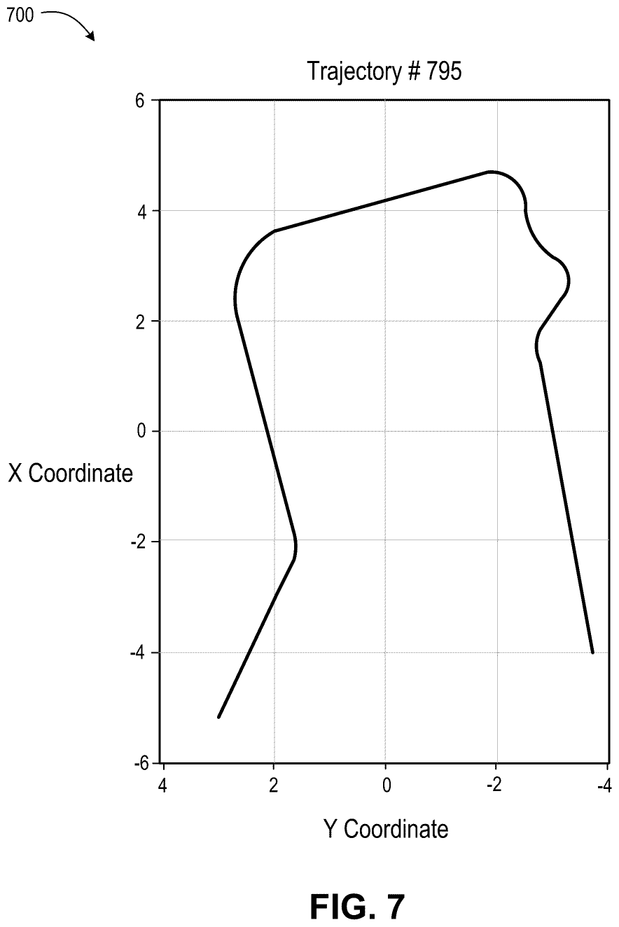

Referring now to FIG. 6, an example histogram 600 of the number of time-steps per trajectory in Dataset #1 is illustratively depicted. Referring now to FIG. 7, an example trajectory 700 of a human in the room, specifically Trajectory #795 from Dataset #2, is illustratively depicted.

The simulation parameters are summarized in Table 1. In this simulation, a sounding reference signal (SRS) may be used as the uplink sensing signal. Two WTRUs with a single antenna may be configured to transmit SRS resource elements (REs) on a 100 MHz bandwidth at 3.7 GHz every 5 ms. Four gNBs with a single antenna may receive the transmitted SRS REs. According to the 5G NR numerology, each WTRU may transmit uplink SRS REs every other subcarrier over 272 resource blocks (RBs) [8]. Therefore, the gNB may receive 6×272=1632 SRS REs from each WTRU in every 5 ms. The NW may aim to use AI/ML-based wireless sensing to predict the position of a human inside the room through the received SRS REs. The human may move at a speed of 1 meter per second within the room. Furthermore, the human may perform four activities in the room: (i) walking, (ii) walking-to-standing (W2S), (iii) standing, and/or (iv) standing-to-walking (S2 W). The system may aim to effectively estimate the human position while the human performs various activities.

TABLE 1
Simulation Parameters

| Number of Antenna at gNB | 1 | |
|---|---|---|
| Number of Antenna at WTRU | 1 | |
| Number of gNBs | 4 | |
| Number of WTRU | 2 | |
| Subcarrier Spacing | 30 | kHz |
| Carrier Frequency | 3.7 | GHz |
| Subcarrier Spacing | 30 | kHz |
| Human Speed | 1 | m/s |
| Bandwidth | 100 | MHz |
| # of RBs used for sensing | 273 | |
| Tx Power | 0 | dBm |
| Noise PSD | −174 | dBm/Hz |
| Noise Figure | 4 | dB |
| SRS Periodicity | 5 | ms |
| Human Speed | 1 | m/s |

Dataset generation may involve generating human trajectories in the room and collecting the channel impulse response (CIR) data through Sionna Ray Tracing. As described in Table 2, Dataset #1 may include 472 trajectories containing only walking activities, whereas Dataset #2 may include 858 trajectories containing all four activities. During AI/ML model training, the datasets may be randomized and shuffled to enable a diverse dataset distribution, allowing the AI/ML model to predict the human position accurately. Each trajectory may begin with the human entering the room, followed by movement within the room, and may conclude with the human leaving the room. The human may be standing during the trajectory if it includes the standing activity, as in the 858 trajectories.

The duration (length) of trajectories may vary based on the walking direction of the human. Since the WTRUs may transmit SRS every 5 ms, the total number of time steps representing the received orthogonal frequency-division multiplexing (OFDM) symbols with SRS REs may be a function of the trajectory length. FIG. 6 depicts a histogram of the number of time steps per trajectory in Dataset #1, which includes only walking activity. The number of time steps may vary between 2420 and 5799. The total number of time steps in Dataset #1 may be 1,821,695. Furthermore, FIG. 7 presents an example human trajectory in the room, corresponding to Trajectory #795 from Dataset #2, which may include all four human activities.

TABLE 2
Dataset Generation

| | |
|---|---|
| Dataset #1: Number of Trajectories with only Walking | 472 |
| Activity | |
| Dataset #2: Number of Trajectories with All Four Activities | 858 |
| (i) Walking, | |
| (ii) Walking-to-Standing (W2S) | |
| (iii) Standing, | |
| (iv) Standing-to-Walk (W2S) | |

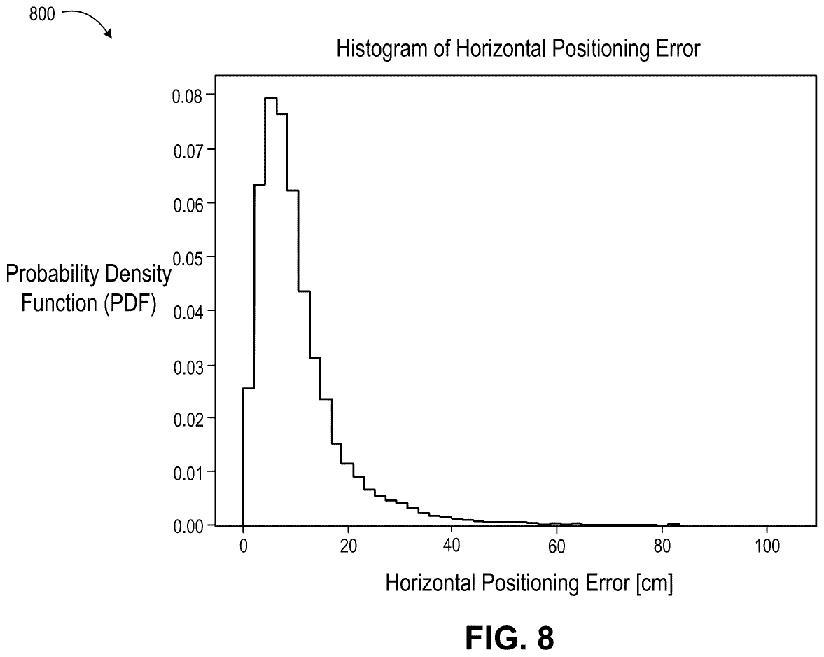

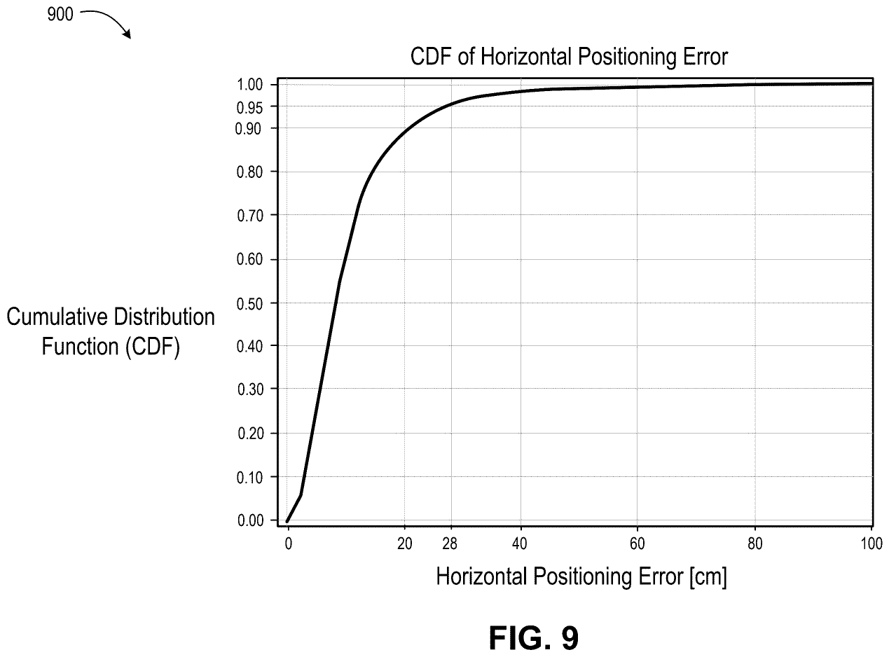

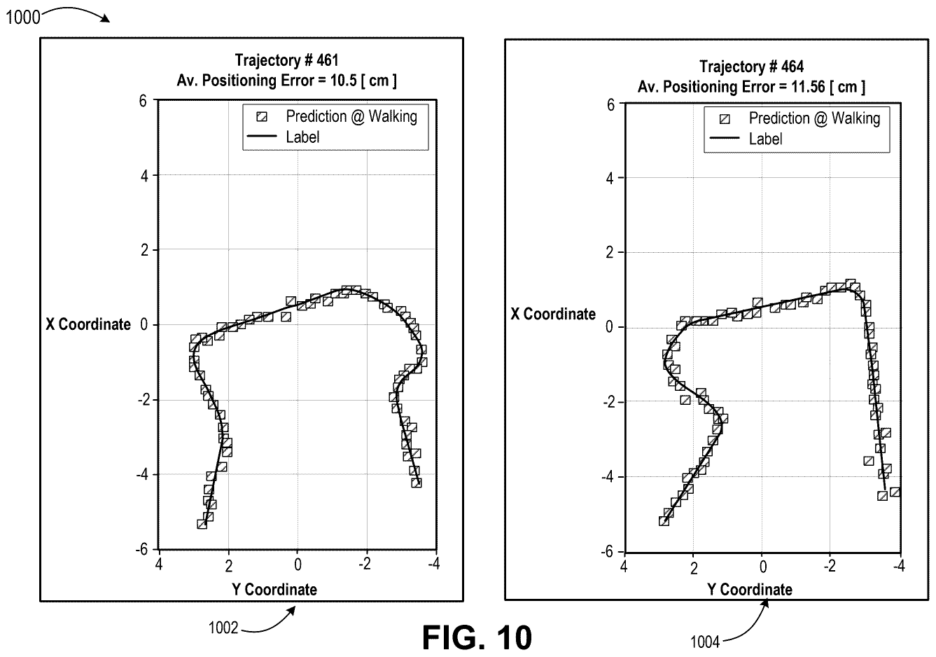

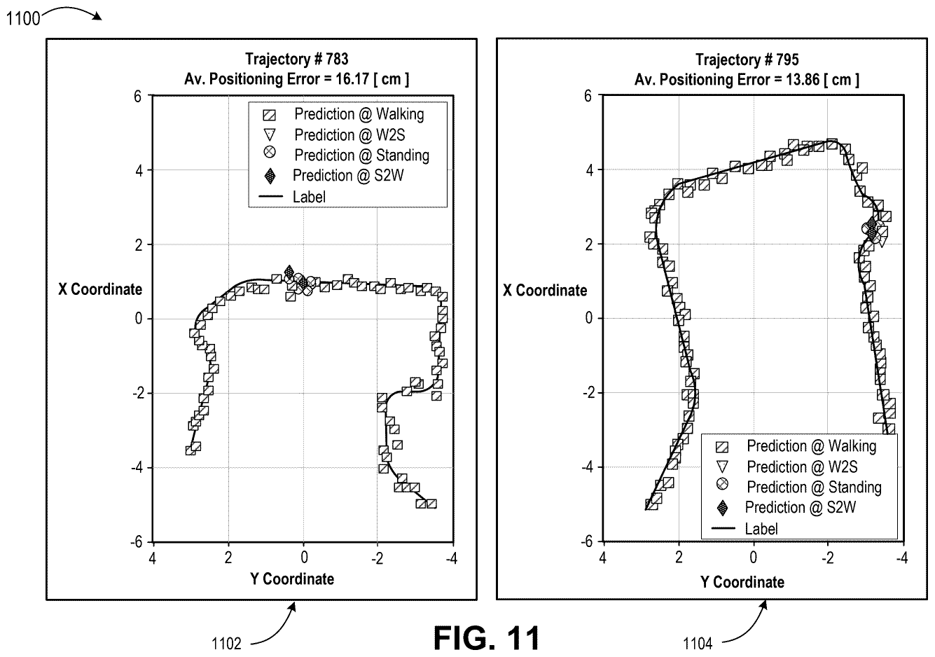

Referring now to FIG. 8, an example histogram of the horizontal positioning error is illustratively depicted. Referring now to FIG. 9, an example cumulative distribution function (CDF) 900 of the horizontal positioning error is illustratively depicted. Referring now to FIG. 10, an example test trajectory 1000 from Dataset #1, specifically Test Trajectory #461, is illustratively depicted. Referring now to FIG. 11, an example test trajectory 1100 from Dataset #2 is illustratively depicted.

The NW may use an AI/ML model for sensing and/or predicting the human location through the received SRS REs. Table 3 summarizes the AI/ML model parameters. The AI/ML model may first apply the following preprocessing steps to the received SRS REs: estimating the uplink channel H through SRS de-rotation (e.g., multiplying the received SRS REs by the conjugate of the known SRS pilot sequence), subtracting the baseline/reference channel H_{ref} (e.g., the uplink channel for the sensing environment without the sensing object) from the estimated uplink channel (e.g., Ĥ−H_{ref}), and performing normalization to the preprocessed uplink channel through

$$\frac{\hat{H} - {H}_{ref}}{c} ,$$

where c may be a scalar.

The AI/ML model may be implemented as shown in FIG. 2 through a convolutional neural network (CNN) and residual network (ResNet) architecture. The input and output dimensions may be selected as shown in Table 3 for the positioning application. Specifically, the AI/ML model input dimension may be, for example, [8,1632,200,2] [8, 1632, 200, 2] [8,1632,200,2], where 8 may refer to the antenna/spatial dimension between 2 WTRUs and 4 gNBs, 1632 may represent the number of subcarriers carrying SRS REs, 200 may represent the most recent 200 SRS observations (e.g., an SRS buffer with 200 timesteps) to dynamically understand the human's position using historical information, and 2 may refer to the concatenation of the real and imaginary parts of the input signal. The AI/ML model may have two outputs corresponding to the x and y coordinates.

After shuffling Dataset #1 and Dataset #2 as expressed in Table 2, the dataset may be split into 90% for training and 10% for testing. Specifically, the first 90% of trajectories in Dataset #1 and Dataset #2 may be used in AI/ML model training (e.g., the first 425 trajectories in Dataset #1 and the first 772 trajectories in Dataset #2 may be utilized for training). The last 47 trajectories from Dataset #1 and the last 86 trajectories from Dataset #2 may be reserved for testing.

TABLE 3
AI/ML Model Training Parameters

| | |
|---|---|
| Input Dimension | [8, 1632, 200, 2] |
| Output Dimension | 2 |
| Total Dataset Size | 178,773 Samples |
| Dataset Split | 90% for Training |
| | 10% for Test |
| Batch Size | 64 |
| Number of Training Iterations per Epoch | 2514 |
| Number of Epochs | 400 |
| Learning Rate | 0.0001 |
| Optimizer | Adam |
| Model Size | 2.85M |

The positioning performance evaluation for AI/ML-based wireless sensing may be presented in this section. The AI/ML model may be extensively trained as described in Table 3. The average positioning error of 10.64 cm may be successfully achieved in the test dataset, as presented in Table 4.

TABLE 4
Average Horizontal Positioning Error

| Dataset | Average horizontal positioning error |
|---|---|
| Training Dataset | 9.05 cm |
| Test Dataset | 10.64 cm |

FIG. 8 and FIG. 9 depict the histogram and cumulative distribution function (CDF) of horizontal positioning error, respectively. FIG. 9 shows that 95% of horizontal positioning errors are less than 28 cm. FIG. 10 and FIG. 11 demonstrate the performance of two test trajectories from Dataset #1 and Dataset #2, respectively. For example, as shown in FIG. 10, the AI-based sensing solution may achieve an average positioning error of 10.5 cm in Test Trajectory #461 from Dataset #1, where the predictions may closely follow the human trajectory. Similarly, as shown in FIG. 11, the AI-based sensing solution may closely predict the human positions even when the human changes activity between walking, W2S, standing, and S2 W.

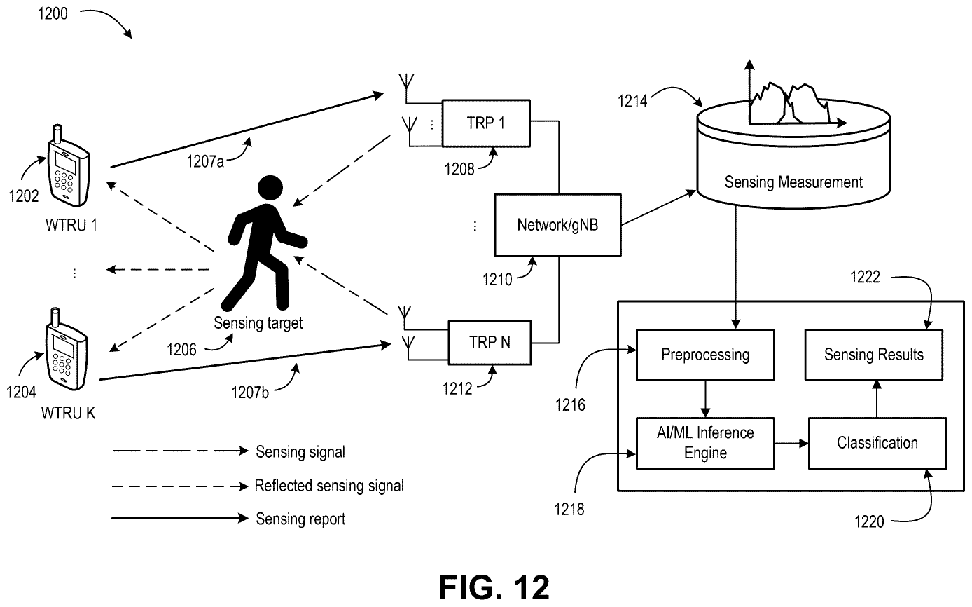

Referring now to FIG. 12, an example AI/ML-based sensing system architecture 1200 for downlink sensing is illustratively depicted. In the downlink sensing scenario, one or more transmission reception points (TRPs) 1208, 1212 or a next-generation Node B (gNB) 1210 may transmit sensing signals. The transmitted sensing signals may interact with the surroundings, for example, sensing signals are blocked by, reflected by and reflected off walls, floors, and/or sensing objects. The sensing signal in the downlink may be a newly defined reference signal for sensing purposes and/or may reuse existing downlink Channel State Information Reference Signal (CSI-RS) and/or Positioning Reference Signal (PRS). One or more receivers, such as wireless transmit/receive units (WTRUs) 1202 and 1204, or consumer premises equipment (CPEs), may receive the transmitted sensing signals and may perform sensing signal measurement. The sensing measurement may include, for example, Channel State Information (CSI).

Each receiver, which may be a WTRU (e.g., WTRU1 1201, WTRUK 1204), may transmit a sensing report 1207a, 1207b to the network based on a sensing target 206. In one implementation, the sensing report may include sensing measurement data, and an AI-based sensing processor 1210 in the network may perform steps such as pre-processing 1216, AI/ML inference (including feature extraction) 1218, and/or classification 1222 to produce sensing results 1220. In some implementations, the WTRU may perform one or more of these steps, such as pre-processing 1214, feature extraction 1216, and/or classification 1220, using AI/ML, and may produce sensing results 1222. The WTRU may then transmit the sensing results 1206 to the network. In other implementations, the NW may perform such steps of preprocessing 1214,

The preprocessing step 1216 may involve transforming the sensing measurement to match the AI/ML model's input shape, range, and/or statistical characteristics. Preprocessing may include, for example, calibration, normalization, and/or amplitude/phase correction. The AI/ML inference engine 1218 may take the preprocessed sensing measurement as input and may produce explicit sensing-related information, which may include, for example, object/target presence probability, location, heading, and/or speed of the detected object/target with respect to a reference anchor, shape and/or characteristics of the detected object/target, and/or activity and/or health-related statistics of a sensing object of interest, such as a human, a car, an autonomous mobile robot (AMR), an automated guided vehicle (AGV), and/or an unmanned aerial vehicle (UAV).

In the classification step 1222, the AI-based sensing processor may apply post-processing to the AI/ML inference engine's 1218 output to determine classification results. The AI-based sensing processor may determine whether an object/target is present based on object/target presence probability. Additionally, and/or alternatively, the AI-based sensing processor may determine the activity of the detected object/target based on activity and/or health-related statistics. Finally, the AI-based sensing processor may aggregate the sensing results 1220 and may transmit them to the next entity and/or node in the sensing task flow for further processing. The entity and/or node may be a sensing function in the core network and/or the radio access network (RAN) 1210, depending on the sensing service invocation and/or the requirements of the corresponding sensing application/task.

The network may be configured to use an AI/ML model for wireless sensing. The AI/ML model may be applied for wireless sensing and may take input data, including, for example, received sensing measurement signals, reference signal received power (RSRP), and/or noise power estimates. The sensing measurement signals may include sensing results obtained at the WTRU. The sensing results may include CSI measurement based on received sensing signals, PRS and/or CSI-RS at the WTRU, pre-processed input data, feature extraction based on input data, and/or classification based on input data.

The preprocessing step at the gNB may include, for example, extracting sensing measurement signals, performing normalization on the sensing measurement signals, concatenating the real and imaginary parts to obtain a real-valued AI/ML model input feature, and reshaping the input data.

The AI/ML-based wireless sensing problem may be formulated as binary classification, multi-class classification (multi-label classification), and/or regression. For example, the AI/ML model may predict a binary decision for object/target detection through wireless sensing, such as decision 0 for the object/target being absent and/or decision 1 for the object/target being present. Referring now to FIG. 3, an example AI/ML model architecture 300 for wireless sensing with binary outputs is illustratively depicted. The model may be constructed using a combination of convolutional neural networks (CNNs), a Residual Network (ResNet), and/or other architectures. The AI/ML model may include convolutional layers, concatenation layers, normalization layers, ReLU activation layers, residual skip connections, and/or sigmoid activation layers. The input feature may include four dimensions as a representation of input data: the antenna/spatial domain, frequency domain, time domain, and/or real and imaginary parts.

The post-processing step may include reshaping the AI/ML model output and performing denormalization of AI/ML model output. The output data of the AI/ML model may include, for example, binary decision for object/target detection, multi-class decision for activity of the detected object/target, multi-class decision for type of detected object/target, such as human, cat, and/or dog, position of the detected object/target in x, y, and/or z coordinates, and/or velocity of the detected object/target.

Training of the AI/ML model may be performed online and/or offline in a supervised manner. Based on the output data, AI/ML-based wireless sensing problems may be formulated as binary classification, multi-class classification (multi-label classification), and/or regression problems.

When a WTRU is configured to perform AI/ML-based sensing, key parameters should be configured by the network, which may include, for example, configuring a group of WTRUs to perform sensing signal measurement. The configuration may include a sensing group ID, WTRU IDs in the group, and an assigned Sensing-Radio Network Temporary Identifier (SEN-RNTI), which allows the network to use group-common downlink control information (DCI) signaling for these WTRUs. A sensing measurement and report configuration message may also be included, specifying the configuration of multiple sensing resources and parameters, such as downlink RBs to be used for sensing, sensing signal density in the time domain, frequency domain, and/or sensing signal sequence length and index, in the downlink for the WTRU to perform sensing measurement and reporting. The message may also configure the WTRU sensing measurement feedback format and/or CSI compression mechanism for sensing purposes. The configuration message may be a radio resource control (RRC) message transmitted from the network. The baseline channel H_{ref} may also be determined for the sensing environment without the sensing object.

For AI/ML-based sensing, signaling may include signaling transmitted from the network to the WTRU for the WTRU to perform measurement for sensing node selection, sensing node selection feedback transmitted from the WTRU to the network, and signaling transmitted from the network to the WTRU for sensing reporting. Additionally, and/or alternatively, signaling may include downlink sensing synchronization reference signals transmitted from an indicated TRP antenna port to the WTRU, a command transmitted from the network to activate one or more downlink sensing resources among the configured sensing resources for the WTRU to use, and signaling from the network indicating WTRU sensing report format and/or CSI compression mechanism for sensing purposes. Further, sensing reports may be transmitted from the WTRU to the network according to the activated and/or configured settings. A command may also be transmitted from the network to the WTRU for the WTRU to adjust sensing signal time interval, frequency density, sensing resource, sensing signal transmission power, and/or other parameters based on sensing performance and/or dynamic sensing conditions.

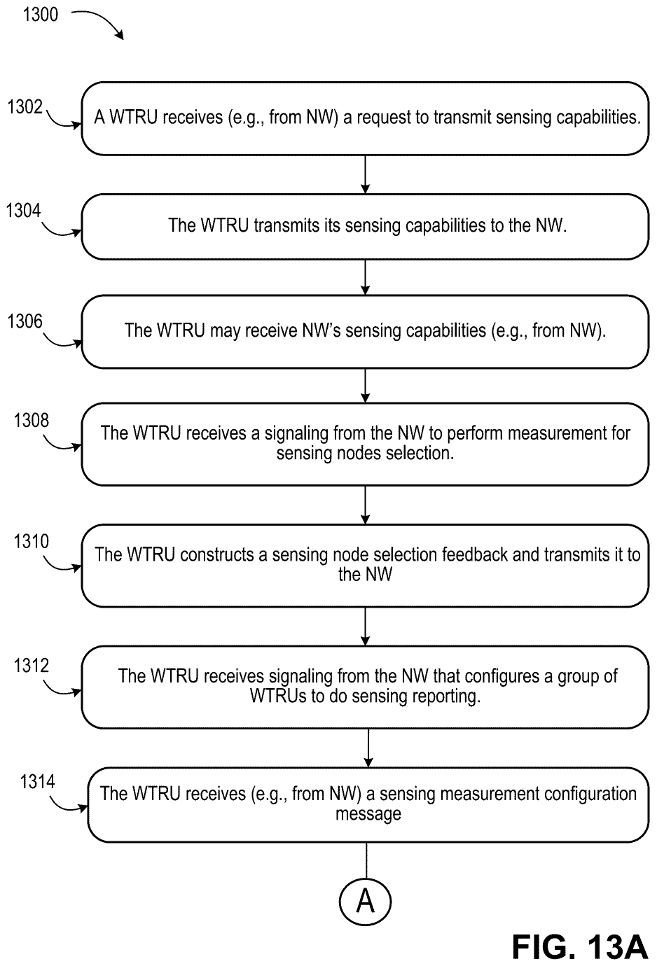

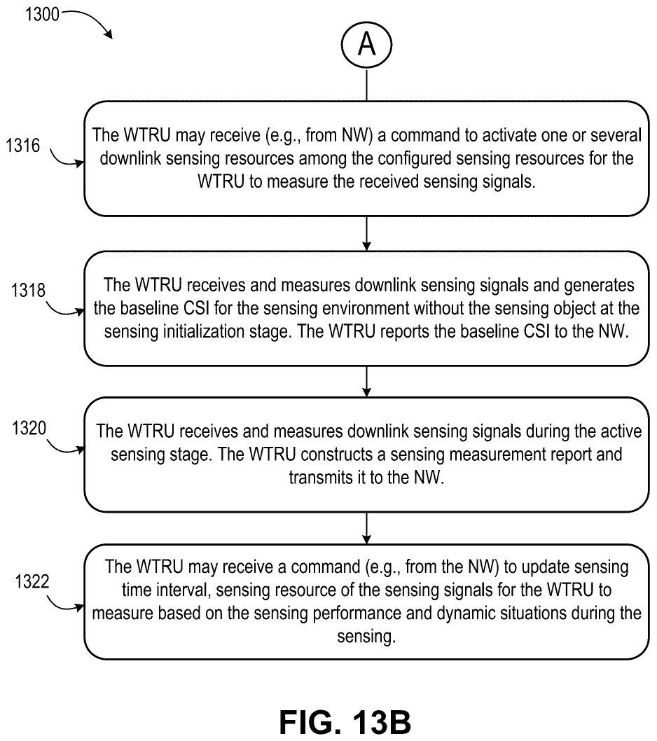

Referring now to FIG. 13, an example method 1300 to perform AI-based sensing in the downlink using a WTRU is illustratively depicted. At 1302, the WTRU may receive a request from the NW to transmit its sensing capabilities. At 1304, the WTRU may transmit its sensing capabilities to the NW. The capabilities message may indicate one or more parameters, including WTRU support for sensing and AI/ML-based sensing, as well as WTRU hardware and/or radio impairments such as phase noise characteristics and/or power amplifier characteristics. The WTRU may transmit its capabilities to the NW by means of RRC signaling.

At 1306, the WTRU may receive NW sensing capabilities, which may indicate one or more parameters such as NW support for sensing and AI/ML-based sensing, as well as NW hardware and/or radio impairments, including phase noise characteristics and/or power amplifier characteristics. The WTRU may receive the NW's capabilities via RRC signaling. At 1308, the WTRU may receive signaling from the NW to perform measurement for sensing node selection. The WTRU may measure the received power from antenna ports of TRPs that are used as sensing signal transmitters.

At 1310, the WTRU may construct a sensing node selection feedback message and transmit it to the NW. The sensing node selection feedback may indicate, but may not be limited to, measured RSSI for each antenna port to the NW, WTRU positioning, and/or CSI. At 1312, the WTRU may receive signaling from the NW that configures a group of WTRUs to perform sensing reporting. The configuration may indicate a sensing group ID, WTRU IDs in the group, and an assigned SEN-RNTI that identifies the group. The SEN-RNTI may allow the NW to use group-common DCI signaling for the WTRUs.

At 1314, the WTRU may receive a sensing measurement configuration message from the NW. The configuration message may be an RRC message transmitted from the NW and may indicate configuration parameters for multiple sensing resources and parameter such as RBs to be used for sensing, sensing signal density in the time domain, frequency domain, sensing signal sequence length, and/or index in the downlink for the WTRU to perform sensing measurement and reporting. The configuration message may also indicate WTRU sensing report format and/or CSI compression mechanism for sensing purposes.

At 1316, the WTRU may receive a command from the NW to activate one or several downlink sensing resources and parameters among the configured sensing resources and parameters for the WTRU to measure the received sensing signals. The WTRU may receive the command through DCI and/or MAC-CE. The amount of downlink sensing resources may depend on the requirements of the corresponding sensing application. At 1318, the WTRU may receive and measure downlink sensing signals and generate baseline CSI for the sensing environment without the sensing object at the sensing initialization stage. The WTRU may report the baseline CSI to the NW.

At 1320, the WTRU may receive and measure downlink sensing signals during the active sensing stage. The WTRU may construct a sensing measurement report and transmit it to the NW. The WTRU may be configured to generate CSI feedback based on the measured downlink sensing signals for the sensing environment with a potential sensing object and report it to the NW depending on the sensing application. If the WTRU is configured to do so, it may use an ML-based CSI compression mechanism model to include the generated CSI in the sensing report. The WTRU may be configured to generate sensing statistics and/or results based on the measured downlink sensing signals for the sensing environment with a potential sensing object during the active sensing stage and report the data to the NW. The WTRU may process the sensing signal measurement locally, perform AI/ML model inference on the measured sensing signals, and produce the sensing statistics and/or results locally. The WTRU may indicate the generated CSI and/or the generated sensing statistics and/or results in the sensing report depending on the sensing application.

At 1322, the WTRU may receive a command from the NW to adjust/update the sensing signal time interval, sensing signal density in the frequency domain, downlink RBs used for sensing, and/or sensing signal transmission power based on the sensing performance and/or dynamic conditions during the sensing process. For example, the WTRU may receive a message from the NW indicating that the sensing time interval is increased and/or the sensing signal density in the frequency domain is reduced when the moving object detection result becomes false and remains false for a predefined period of time. The WTRU may receive such a command through DCI and/or MAC-CE. If the WTRU processes the sensing signal measurement and generates sensing results locally, then the WTRU may have knowledge of sensing performance and/or dynamic conditions during the sensing process. The WTRU may request that the NW adjust these sensing parameters using uplink signaling and/or data channels.

The NW may transmit its sensing capabilities request to the WTRU. The NW may receive the sensing capabilities from the WTRU. The NW may transmit the NW sensing capabilities to the WTRU. The NW may send a message to the WTRU, which may signal the WTRU to perform measurement for sensing node selection. The NW may receive the sensing node selection measurement from the WTRU. The NW may use these measurements to determine and indicate which antenna port to use for sensing synchronization. The NW may transmit downlink sensing synchronization reference signals from an indicated TRP antenna port.

The NW may configure a group of WTRUs to perform sensing signal measurement and reporting. The configuration may indicate a sensing group ID, WTRU IDs in the group, and an assigned SEN-RNTI that identifies the group. The NW may use the SEN-RNTI to scramble the CRC of a particular DCI to send sensing-related signals to this group of WTRUs. The NW may use group-common sensing signaling for these WTRUs to reduce signaling overhead.

Based on the requirements of the sensing application, the NW may select appropriate sensing resources and parameters among the sensing resources and parameters configured for the WTRU in the downlink. For each sensing application, the NW may use DCI and/or MAC-CE to indicate one set of sensing signal power control parameters for the WTRU to use. The NW may configure multiple power offset values and/or path loss compensation factors for sensing signal power control.

The NW may receive sensing reports from the UE for the sensing environment without the sensing object and may generate the baseline CSI data for the sensing environment without the sensing object. The NW may perform pre-processing of the received sensing signals.

The input features are fed into an AI/ML model trained for wireless sensing. The AI/ML model predicts/outputs the sensing results through the pre-processed input feature. Sensing results may include object/target detection, and activity of detected object/target, and etc.

When the moving object detection result is false, the NW may collect data to update H_{ref}. The dataset may be collected and stored with timestamps to balance robustness and performance. The NW may use RF digital twins and Sionna raytracing to generate the ground truth label and/or dataset for the sensing of the target object. As additional H_{ref} data are collected over time, the database of H_{ref} may be continuously updated. The updated database may then serve as input to the Sionna raytracing tool, which may use the new data to refine and/or enhance the RF digital twin model and/or environment.

For example, in an indoor environment, differential locations of furniture and/or wall material properties may be trained to match H_{ref} data. When the NW detects a change in the RF digital twin environment, sensing ML models may be triggered to re-train on new channels and/or CIRs generated from the updated RF digital twin environment, such as those created by Sionna Ray Tracing. The history of H_{ref} changes over time may be saved and added to the training dataset so that the sensing and/or its performance may be more robust to sensing environment changes. For example, the sensing environment change may be caused by moving furniture.

Based on the sensing performance and/or dynamic conditions during the sensing process, the NW may adjust the downlink sensing signal time interval, frequency domain density, sensing resources, sensing signal transmission power, and/or other parameters and may signal the change to the WTRU. The NW may switch between different sensing detection modes. For example, when the moving object detection result becomes false and remains false for a predefined period of time, the NW may decide to increase the sensing time interval and/or reduce the sensing signal density in the frequency domain for downlink sensing transmissions and may signal the change to the WTRU. The NW may change the sensing detection mode to “object detection only.”

Additionally, and/or alternatively, the NW may receive signaling from the WTRU requesting an adjustment to the sensing parameters. The NW may grant and/or reject the request. In the scenarios of sidelink communication, device-to-device (D2D) communication, and vehicle-to-everything (V2X) communication, the procedures of the NW node described above may be performed by a WTRU.

1. A wireless transmit/receive unit (WTRU) comprising:
a processor configured to:
receive an indication from a network to perform measurements associated with uplink sensing;
determine sensing node selection feedback based on the indication;
transmit the sensing node selection feedback to the network;
receive an indication from the network that assigns the WTRU to a sensing group;
receive configuration information associated with uplink sensing, wherein the configuration information comprises an indication of a plurality of sensing resources, a plurality of parameters, and an indication of a transmission mode;
receive an indication to activate at least one uplink sensing resource among the plurality of sensing resources and a set of sensing signal parameters from the plurality of parameters, wherein the indication indicates the transmission mode; and
send, via the at least one uplink sensing resource, a sensing signal, the set of sensing signal parameters from the plurality of parameters, and the transmission mode that were activated, wherein the transmission mode is a normal transmission mode or a pre-equalized transmission mode.

2. The WTRU of claim 1, wherein the indication indicates sensing signal power control parameters, and wherein the sensing signal power control parameters comprises a power offset value or a path loss compensation factor; and
wherein the processor is configured to send the sensing signal based on the sensing signal power control parameters.

3. The WTRU of claim 1, wherein the configuration information indicates a sensing signal time interval, a frequency domain density, or sensing signal transmit power control parameters; and
wherein the processor is configured to send the sensing signal using the sensing signal time interval, the frequency domain density, or the sensing signal transmit power control parameters indicated by the configuration information.

4. The WTRU of claim 1, wherein the processor is configured to send the sensing signal using the pre-equalized transmission mode by applying a pre-equalizer (PEQ) to the sensing signal.

5. The WTRU of claim 4, wherein the processor is configured to determine the pre-equalizer based on a reference channel estimate.

6. The WTRU of claim 4, wherein the processor is configured to receive a signal by the network to use a pre-equalizer from a set of quantized pre-equalizers configured by the network.

7. The WTRU of claim 4, wherein the processor is configured to generate the pre-equalizer using an artificial intelligence (AI) or machine learning (ML) model.

8. The WTRU of claim 1, wherein the sensing signal comprises an uplink sounding reference signal (SRS).

9. The WTRU of claim 1, wherein the processor is configured to receive a downlink sensing synchronization reference signal from a transmission/reception point (TRP) to align time synchronization with other WTRUs in a sensing group.

10. The WTRU of claim 1, wherein the processor is configured to:
send one or more additional sensing signals via at least one additional uplink sensing resource among the one or more sensing resources using at least one of an adjusted sensing signal time interval, an adjusted sensing signal frequency domain density, or an adjusted sensing signal transmit power control parameters.

11. The WTRU of claim 10, wherein the processor is configured to:
receive a message from the network that indicates the adjusted sensing signal time interval, the adjusted sensing signal frequency domain density, or the adjusted sensing signal transmit power control parameters.

12. The WTRU of claim 1, wherein the sensing node selection feedback comprises a received signal strength indicator (RSSI) associated with one or more antenna ports of the WTRU, a position of the WTRU, channel state information (CSI), or an indication of a preferred transmission mode of the WTRU.

13. The WTRU of claim 1, wherein the indication that assigns the WTRU to the sensing group comprises a sensing radio network temporary identifier (SEN-RNTI).

14. A method implemented by a wireless transmit/receive unit (WTRU) comprising:
receiving an indication from a network to perform measurements associated with uplink sensing;
determining sensing node selection feedback based on the indication;
transmitting the sensing node selection feedback to the network;
receiving an indication from the network that assigns the WTRU to a sensing group;
receiving configuration information associated with uplink sensing, wherein the configuration information comprises an indication of a plurality of sensing resources, a plurality of parameters, and an indication of a transmission mode;
receiving an indication to activate at least one uplink sensing resource among the plurality of sensing resources and a set of sensing signal parameters from the plurality of parameters, wherein the indication indicates the transmission mode; and
sending, via the at least one uplink sensing resource, a sensing signal, the set of sensing signal parameters from the plurality of parameters, and the transmission mode that were activated, wherein the transmission mode is a normal transmission mode or a pre-equalized transmission mode.

15. The method of claim 14, further comprising sending the sensing signal based on sensing signal power control parameters, wherein the indication indicates sensing signal power control parameters, and wherein the sensing signal power control parameters comprises a power offset value or a path loss compensation factor.

16. The method of claim 14, wherein the configuration information indicates a sensing signal time interval, a frequency domain density, or sensing signal transmit power control parameters; and
further comprising sending the sensing signal using the sensing signal time interval, the frequency domain density, or sensing signal transmit power control parameters indicated by the configuration information.

17. The method of claim 14, further comprising one or more of:
sending the sensing signal using the pre-equalized transmission mode by applying a pre-equalizer (PEQ) to the sensing signal;
determining the pre-equalizer based on a reference channel estimate;
receiving a signal from the network to use a pre-equalizer from a set of quantized pre-equalizers configured by the network; or
generating the pre-equalizer using an artificial intelligence (AI) or machine learning (ML) model.

18. The method of claim 14, further comprising one or more of:
sending one or more additional sensing signals via at least one additional uplink sensing resource among the one or more sensing resources using at least one of an adjusted sensing signal time interval, an adjusted sensing signal frequency domain density, or an adjusted sensing signal transmit power control parameters, or
receiving a message from the network that indicates the adjusted sensing signal time interval, the adjusted sensing signal frequency domain density, or the adjusted sensing signal transmit power control parameters.

19. The method of claim 14, wherein the sensing node selection feedback comprises a received signal strength indicator (RSSI) associated with one or more antenna ports of the WTRU, an indication of a position of the WTRU, channel state information (CSI), or an indication of a preferred transmission mode of the WTRU.

20. The method of claim 14, wherein the indication that assigns the WTRU to the sensing group comprises a sensing radio network temporary identifier (SEN-RNTI).
